(19) United States
(12) Patent Application Publication
(10) Pub. No.: US 2025/0189695 A1
(43) Pub. Date: Jun. 12, 2025

(54) IMAGE SENSOR MODULE, CAMERA MODULE AND ELECTRONIC DEVICE

(71) Applicant: Largan Industrial Optics Co., Ltd., Taichung City (TW)

(72) Inventors: Tzu-Kan CHEN, Taichung City (TW); Ti Lun LIU, Taichung City (TW); Jih Chung HUANG, Taichung City (TW); Yu-Pin WANG, Taichung City (TW); Yu-Chen LAI, Taichung City (TW); Ming-Ta CHOU, Taichung City (TW); Pei-Chi CHANG, Taichung City (TW)

(21) Appl. No.: 18/964,621

(22) Filed: Dec. 1, 2024

Related U.S. Application Data
(60) Provisional application No. 63/606,632, filed on Dec. 6, 2023.

(30) Foreign Application Priority Data
Oct. 16, 2024 (TW) 113139408

(51) Int. Cl. G02B 1/11; G02B 5/00; G02B 5/20

(52) U.S. Cl. CPC G02B 1/11; G02B 5/003; G02B 5/20

(57) ABSTRACT

An image sensor module has a light path, and includes an image sensor, a reflecting element, an optical multilayer deposition structure layer and a nano-rough surface. The image sensor corresponds to the light path. The reflecting element faces towards and is adjacent to the image sensor, and the reflecting element is configured to fold the light path. The optical multilayer deposition structure layer is farther away from the image sensor than the reflecting element away from the image sensor along the light path. The nano-rough surface is disposed on one side of the image sensor facing towards the reflecting element, and the nano-rough surface includes a plurality of nano-protruding structures. Shapes of the nano-protruding structures are irregular, and the nano-protruding structures are arranged adjacent to each other.

### RELATED APPLICATIONS

This application claims priority to U.S. Provisional Application Ser. No. 63/606,632, filed Dec. 6, 2023, and Taiwan Application Ser. No. 113139408, filed Oct. 16, 2024, which are herein incorporated by references.

### BACKGROUND

### Technical Field

The present disclosure relates to an image sensor module and a camera module. More particularly, the present disclosure relates to an image sensor module and a camera module applicable to portable electronic devices.

### Description of Related Art

In recent years, portable electronic devices have developed rapidly. For example, intelligent electronic devices and tablet computers have been filled in the lives of modern people, and camera modules and image sensor modules thereof mounted on the portable electronic devices have also prospered. However, as technology advances, the quality requirements of the image sensor module are becoming higher and higher.

Specifically, infrared light is easier to penetrate a light blocking element than visible light to penetrate the light blocking element. Thus, infrared light is easier to penetrate the original light-blocking position from the light path folding position to the image sensing surface. As a result, the image will be incorrectly exposed light and unable to present correct colors. Therefore, an image sensor module, which can improve the problem of glare generated by infrared light on a catadioptrics telephoto lens assembly, needs to be developed.

### SUMMARY

According to one aspect of the present disclosure, an image sensor module has a light path, and includes an image sensor, a reflecting element, an optical multilayer deposition structure layer and a nano-rough surface. The image sensor corresponds to the light path. The reflecting element faces towards and is adjacent to the image sensor, and the reflecting element is configured to fold the light path. The optical multilayer deposition structure layer is farther away from the image sensor than the reflecting element away from the image sensor along the light path, wherein a reflectance of the optical multilayer deposition structure layer corresponding to a light with a wavelength from 450 nm to 600 nm is less than or equal to 10%. The nano-rough surface is disposed on one side of the image sensor facing towards the reflecting element, wherein the nano-rough surface includes a plurality of nano-protruding structures. Shapes of the nano-protruding structures are irregular, and the nano-protruding structures are arranged adjacent to each other. A width of each of the nano-protruding structures is smaller than or equal to 300 nm, and a height of each of the nano-protruding structures is smaller than or equal to 350 nm. A reflectance of the nano-rough surface corresponds to a reflectance of the optical multilayer deposition structure layer. When a wavelength with a reflectance of the optical multilayer deposition structure layer being 50% is R50, a maximum reflectance of the nano-rough surface corresponding to a wavelength from 450 nm to R50 is less than or equal to 0.49%, and the following condition is satisfied: 600 nm≤R50≤720 nm.

According to one aspect of the present disclosure, a camera module includes the image sensor module according to the aforementioned aspect and an imaging lens assembly. The imaging lens assembly is disposed on an object side of the image sensor module along the light path.

According to one aspect of the present disclosure, an electronic device includes the camera module according to the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional schematic view of a camera module according to the 1st embodiment of the present disclosure.

FIG. 1B is a cross-sectional view of the camera module according to the 1st embodiment of FIG. 1A.

FIG. 1C is another cross-sectional view of the camera module according to the 1st embodiment of FIG. 1A.

FIG. 1D is a scanning electron microscope image of an image sensor and a nano-rough surface according to the 1st embodiment of FIG. 1A.

FIG. 1E is a partial schematic view of the camera module according to the 1st example of the 1st embodiment of FIG. 1A.

FIG. 1F is a partial enlarged view of the image sensor module according to the 1st example of the 1st embodiment of FIG. 1E.

FIG. 1G is a partial schematic view of the camera module according to the 2nd example of the 1st embodiment of FIG. 1A.

FIG. 1H is a three-dimensional schematic view of the prism according to the 3rd example of the 1st embodiment of FIG. 1A.

FIG. 11 is a schematic view of the prism according to the 3rd example of the 1st embodiment of FIG. 1H.

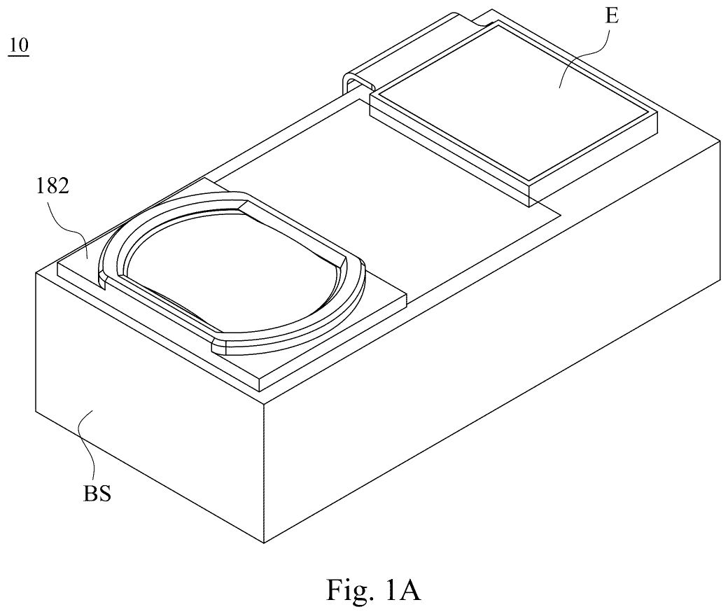

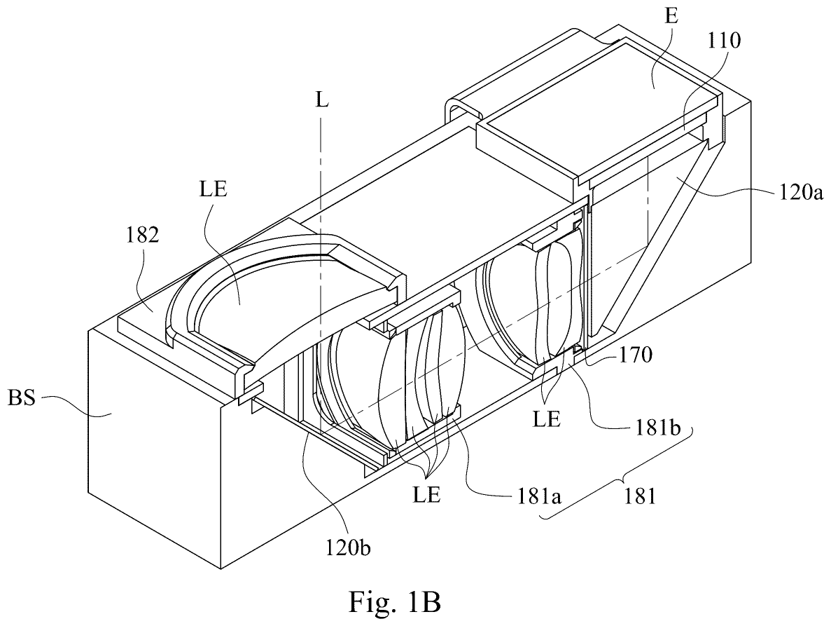

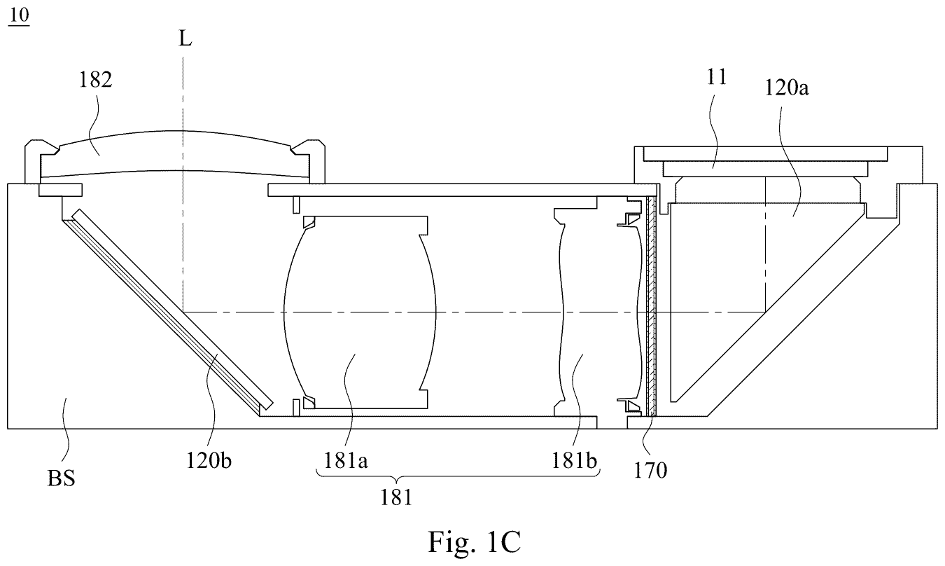

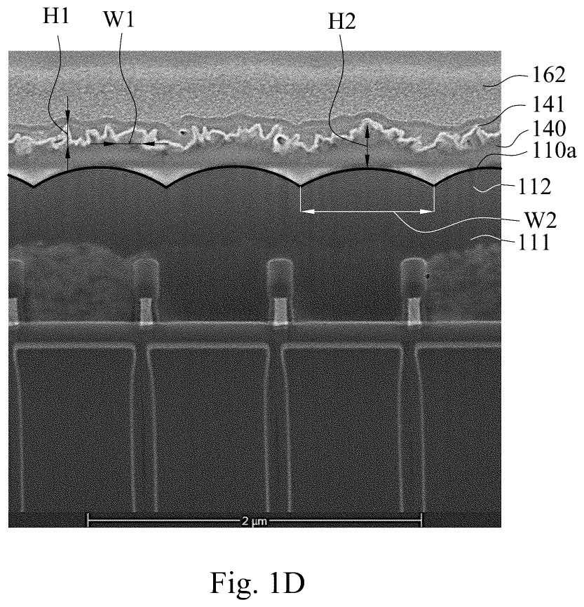

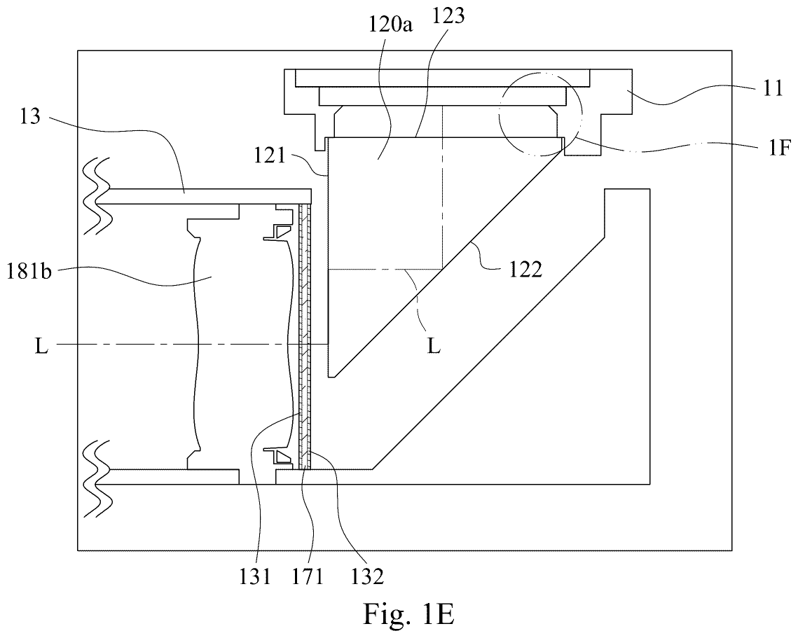

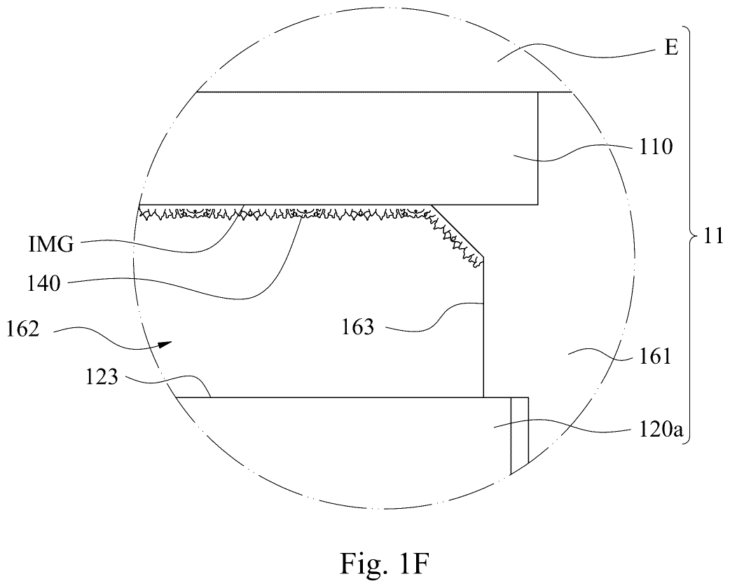

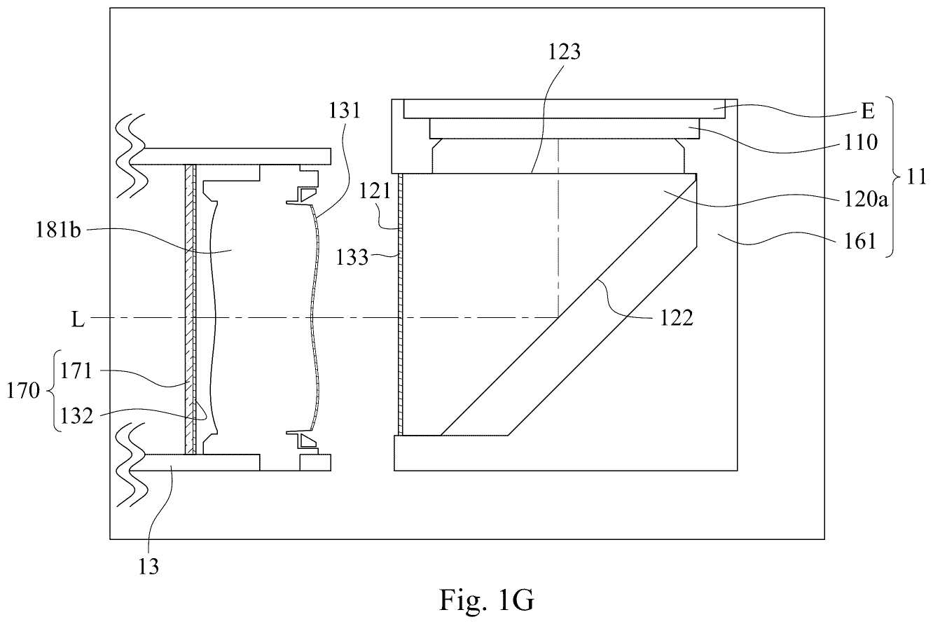

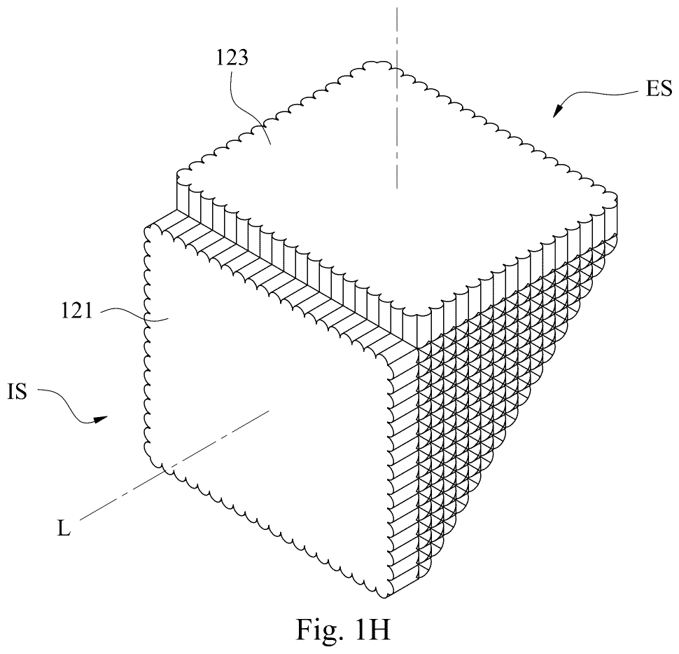

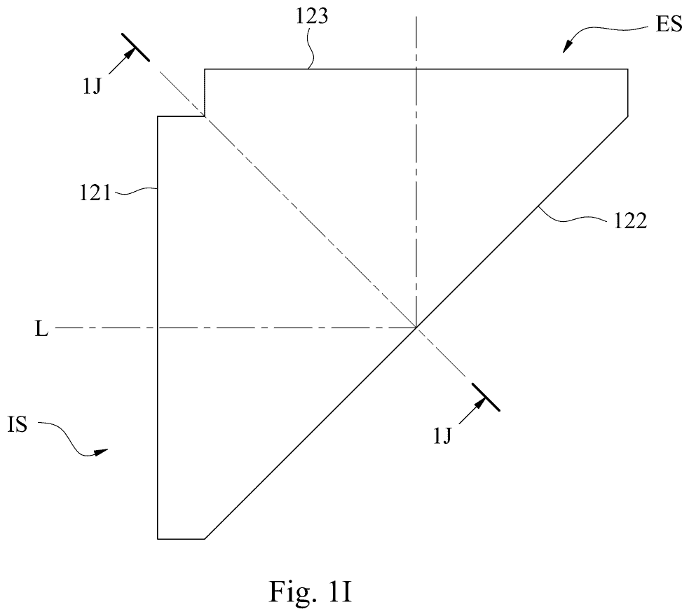

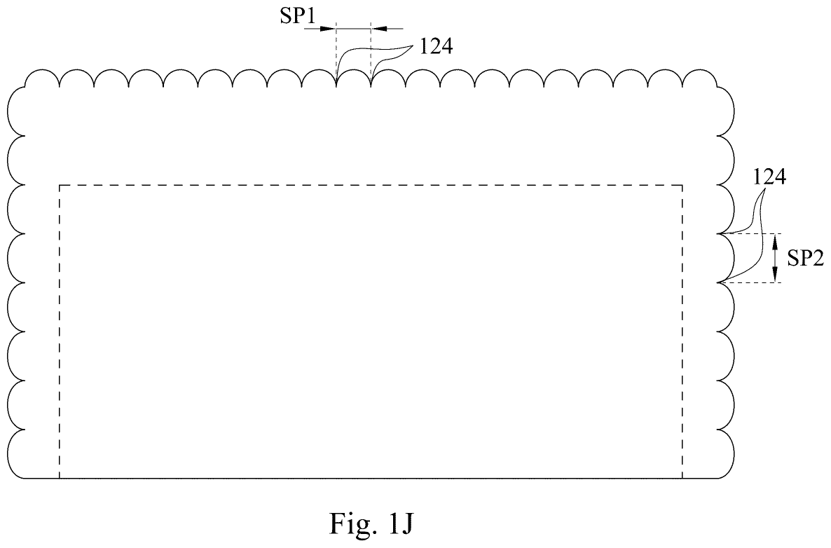

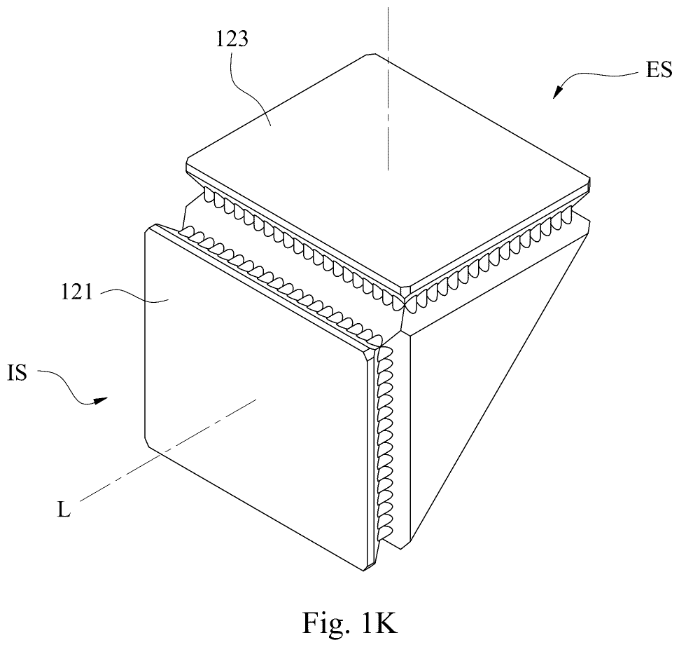

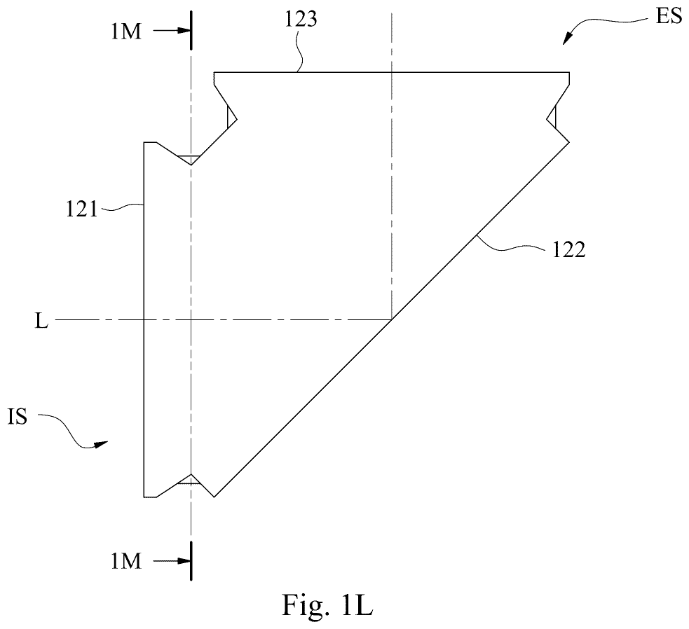

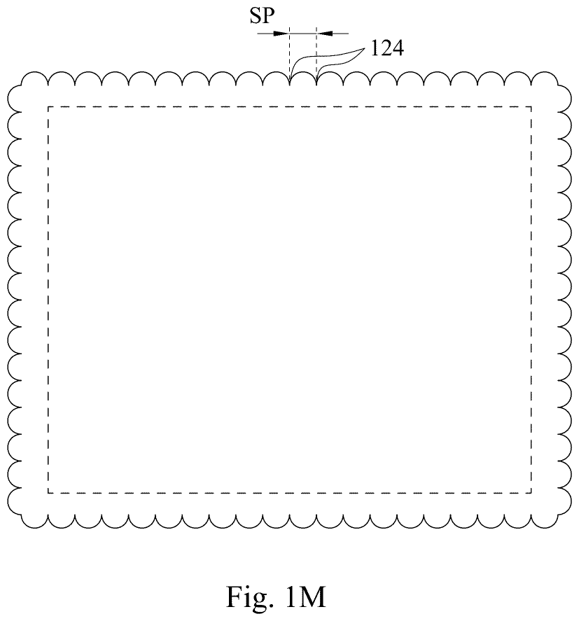

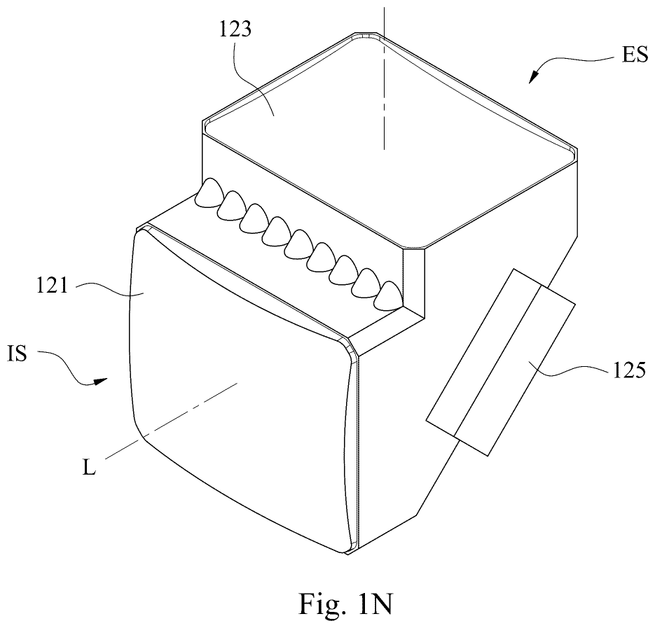

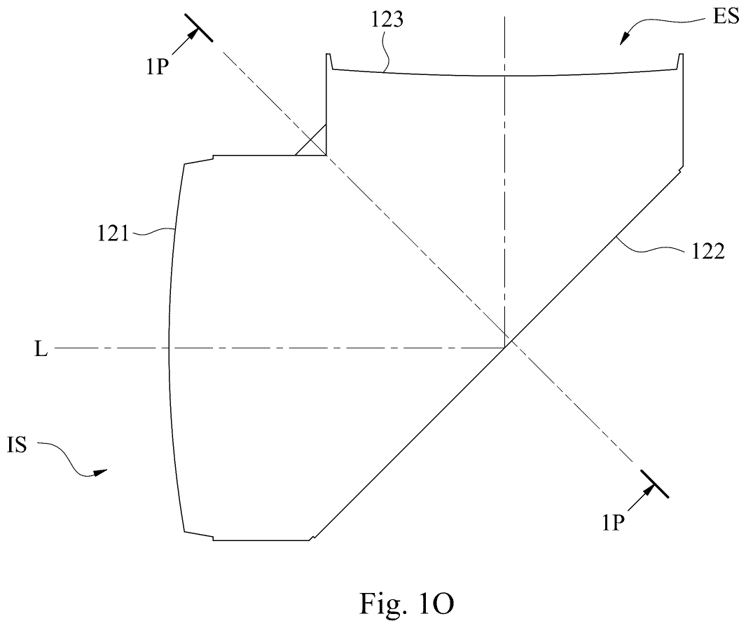

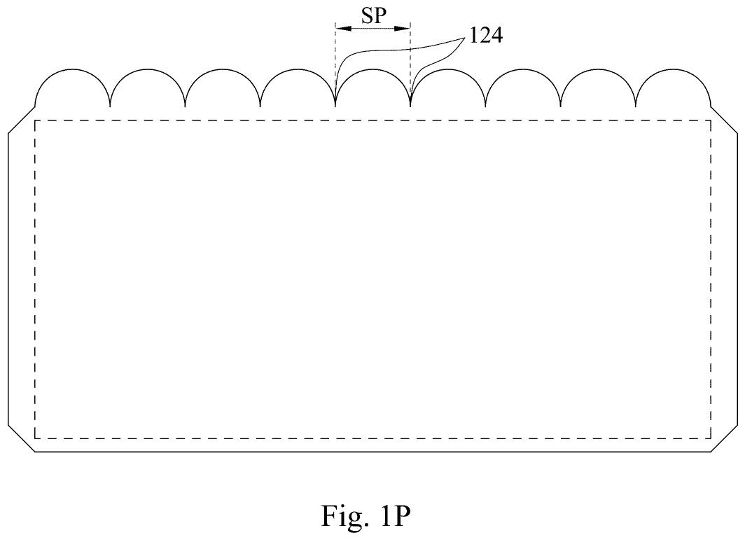

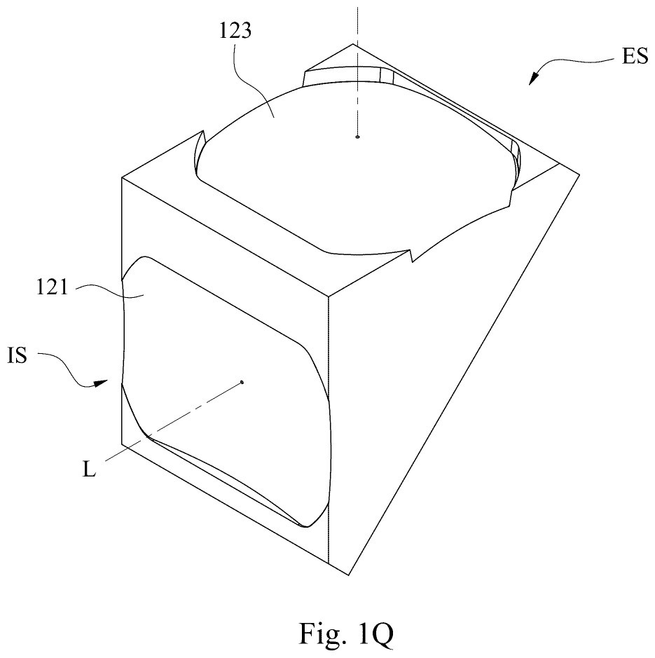

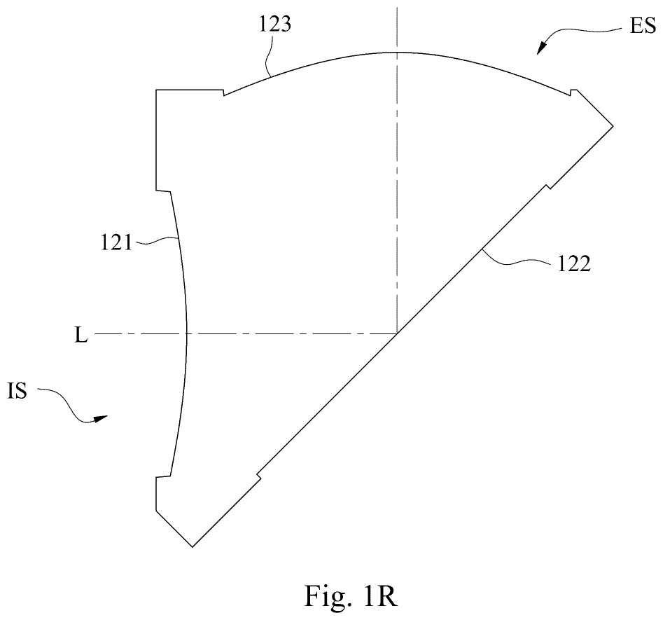

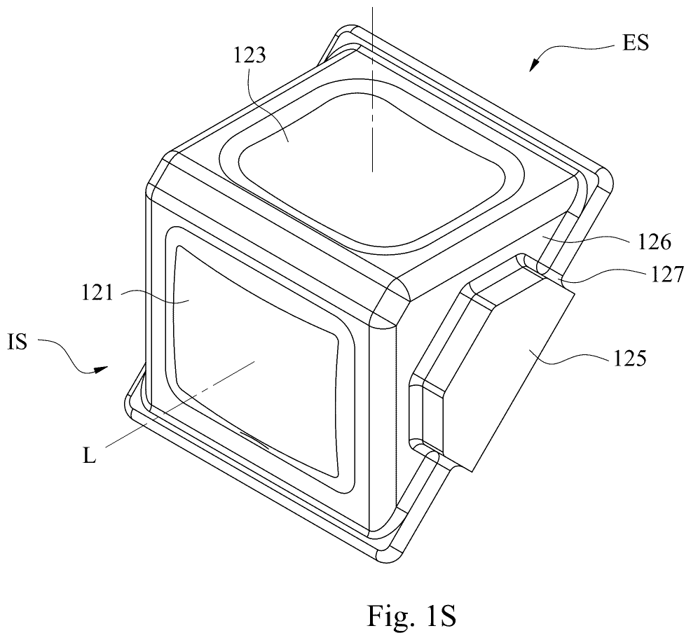

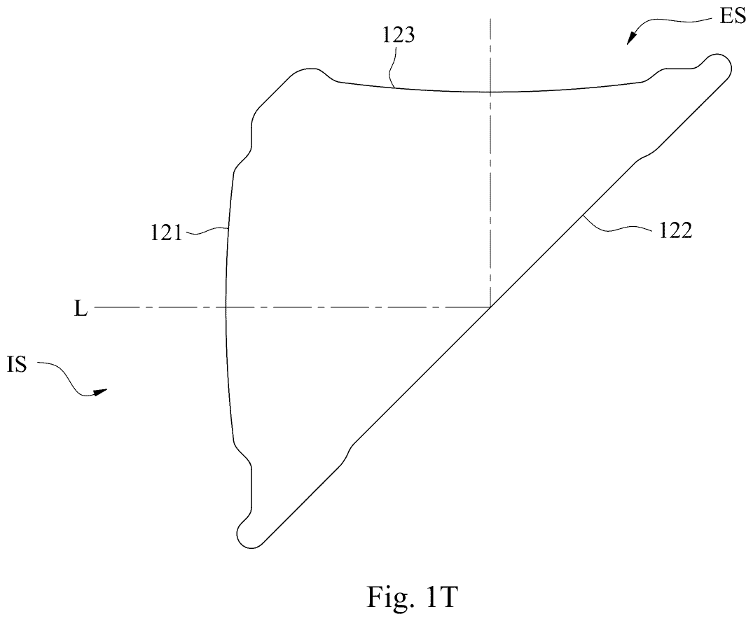

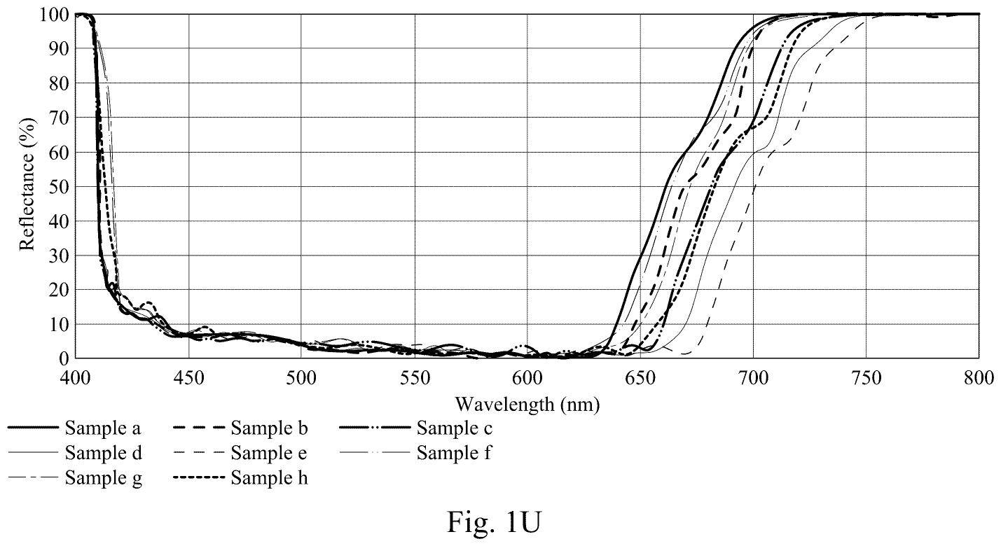

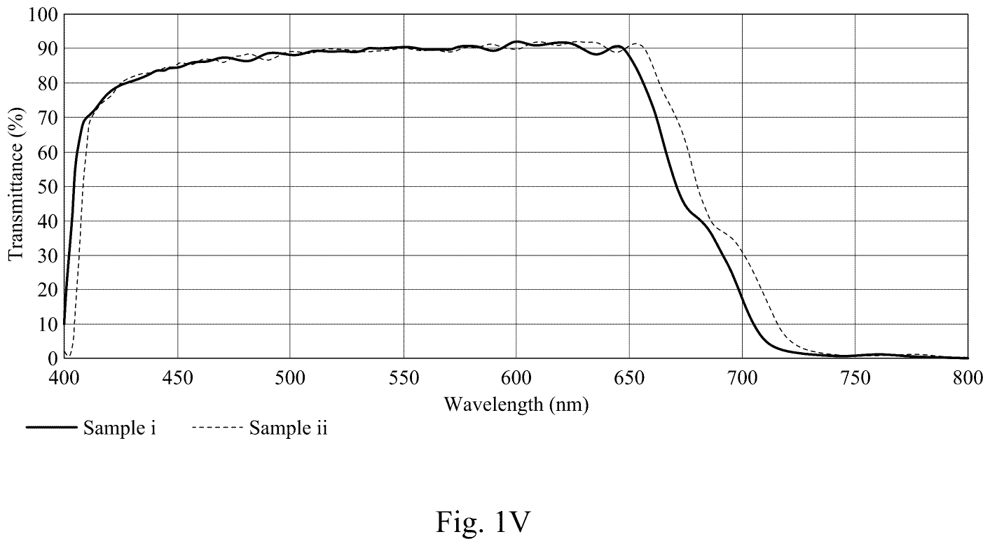

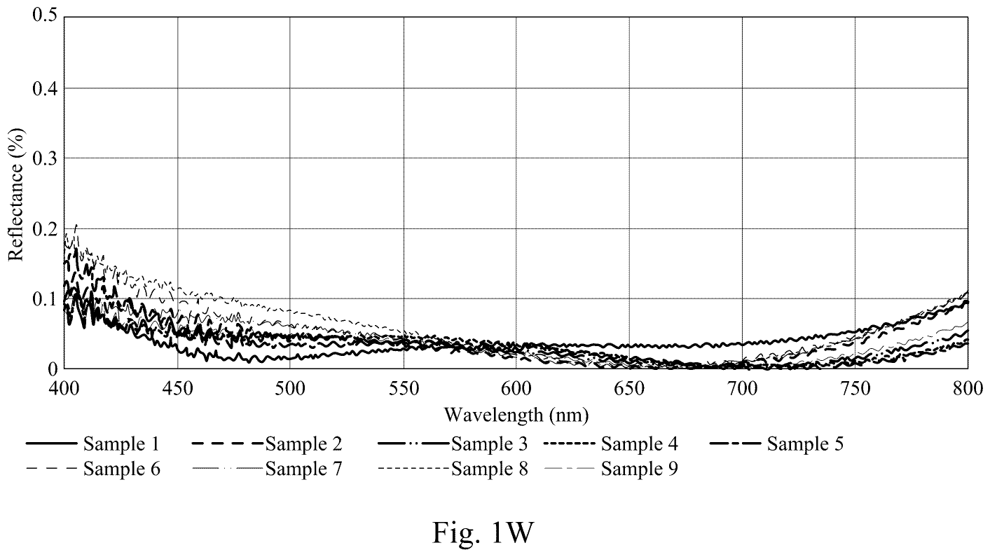

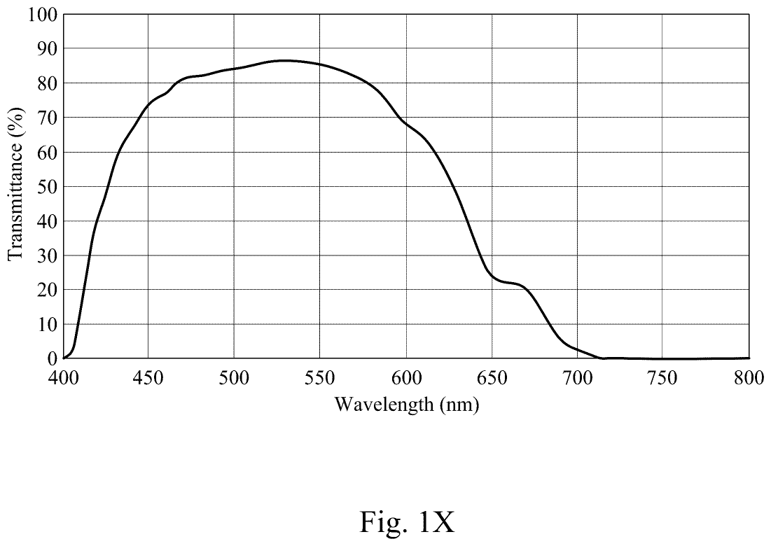

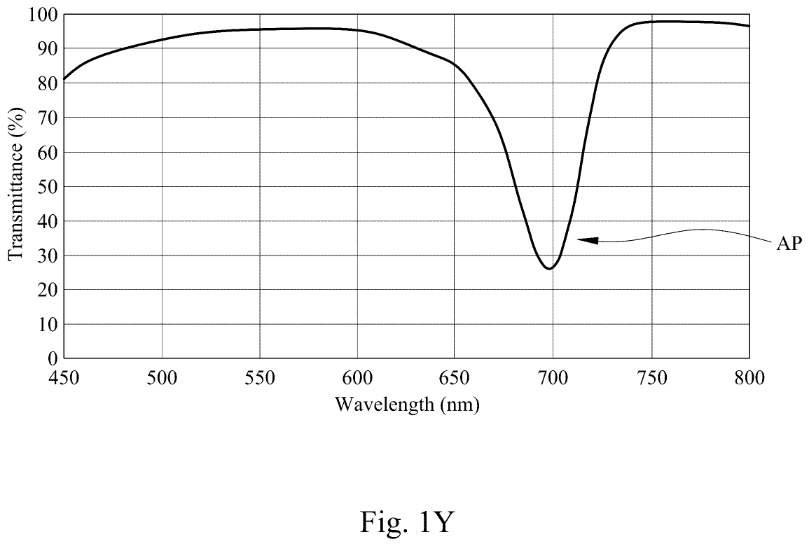

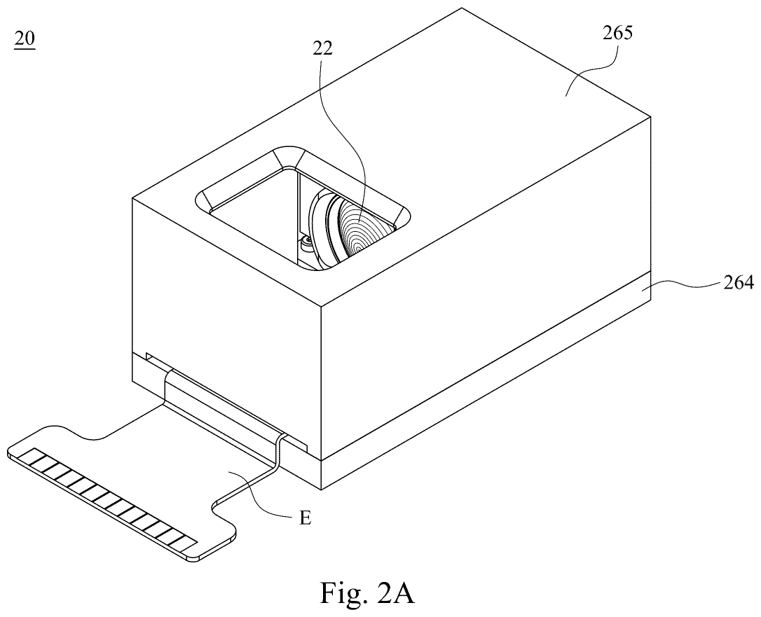

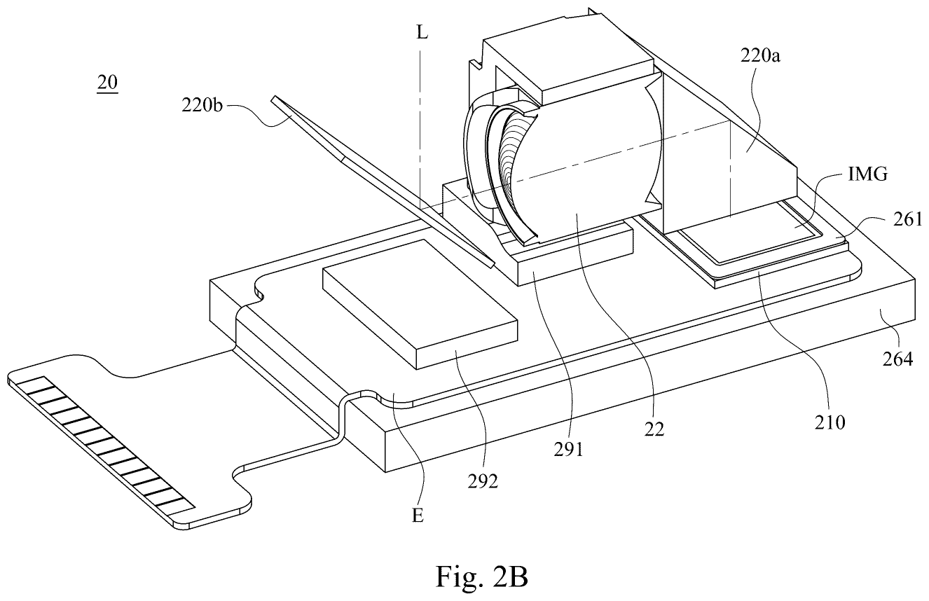

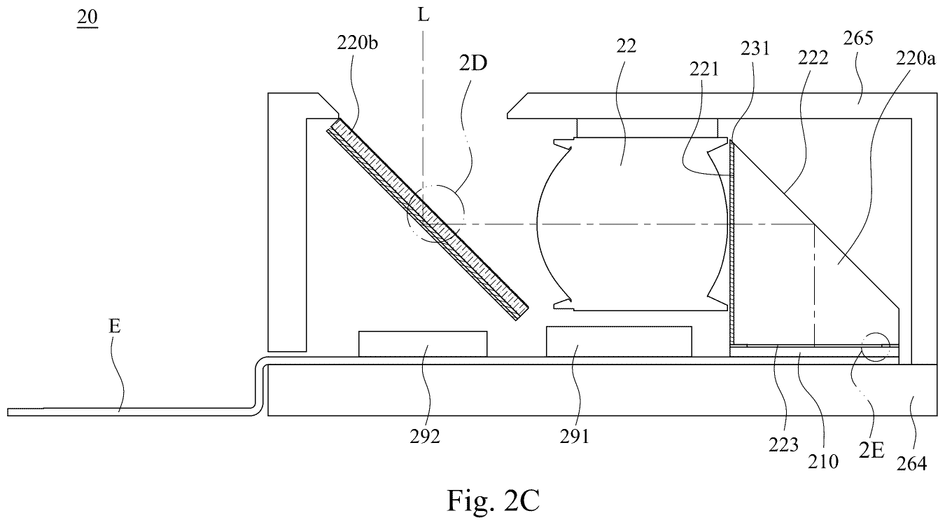

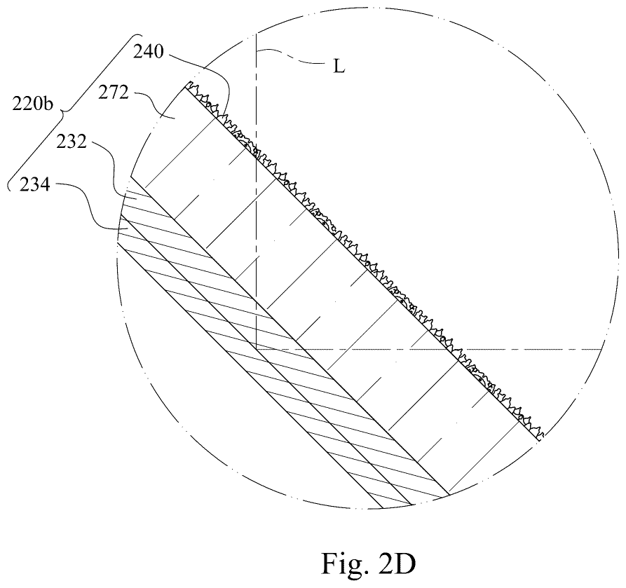

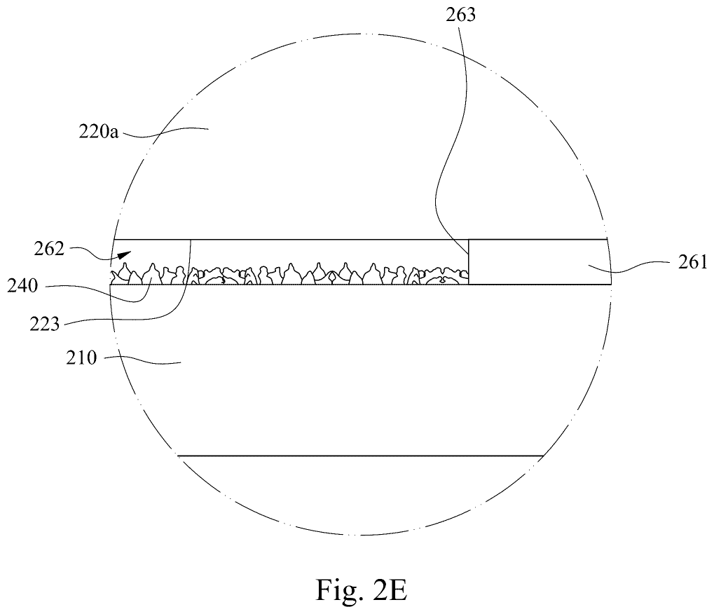

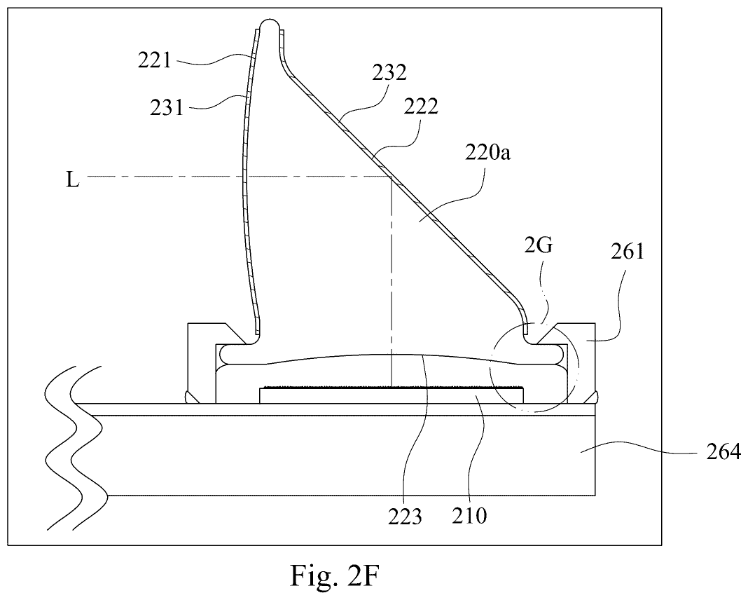

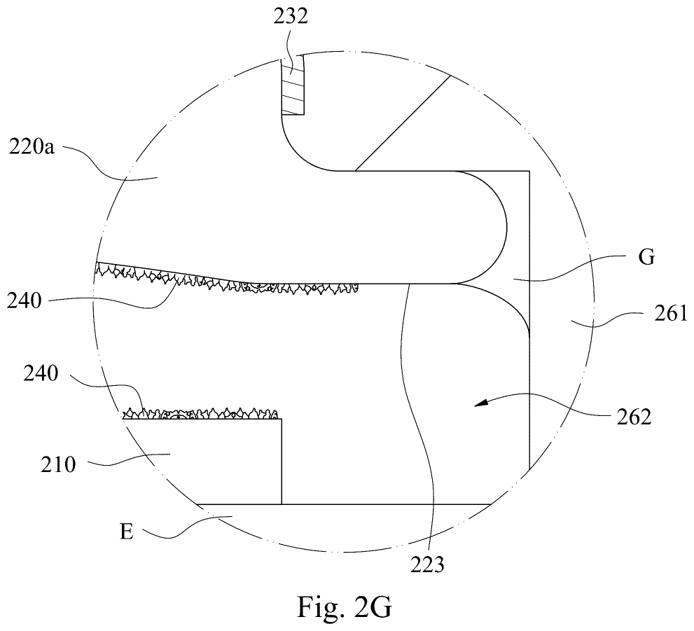

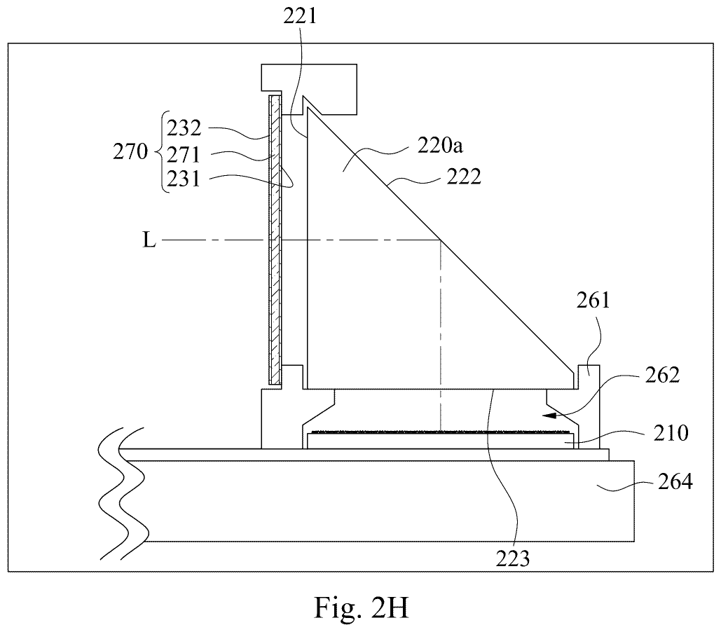

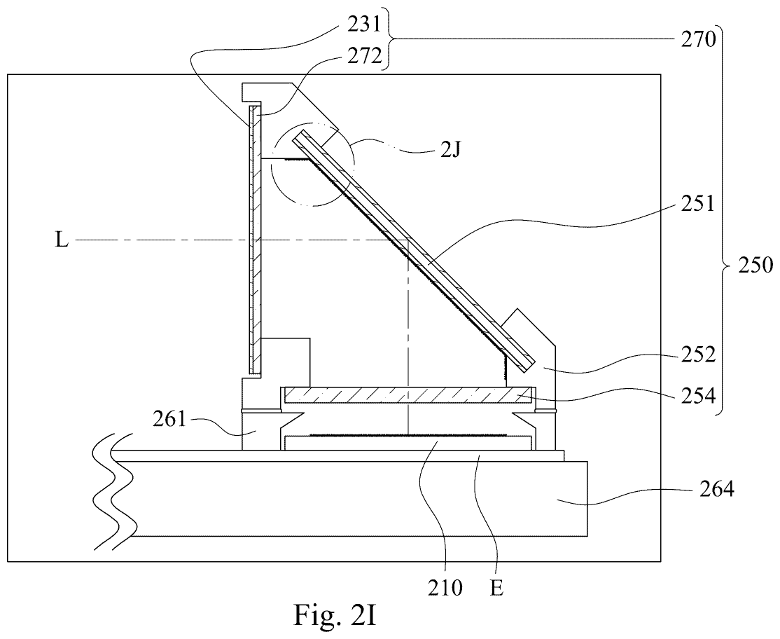

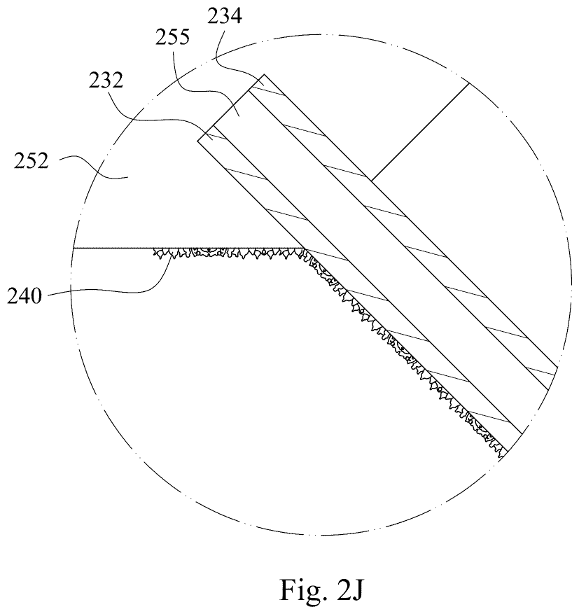

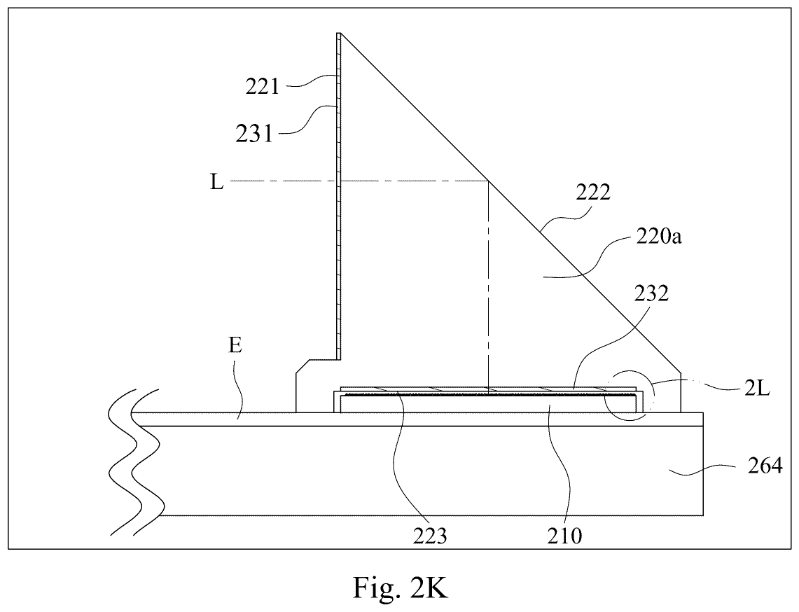

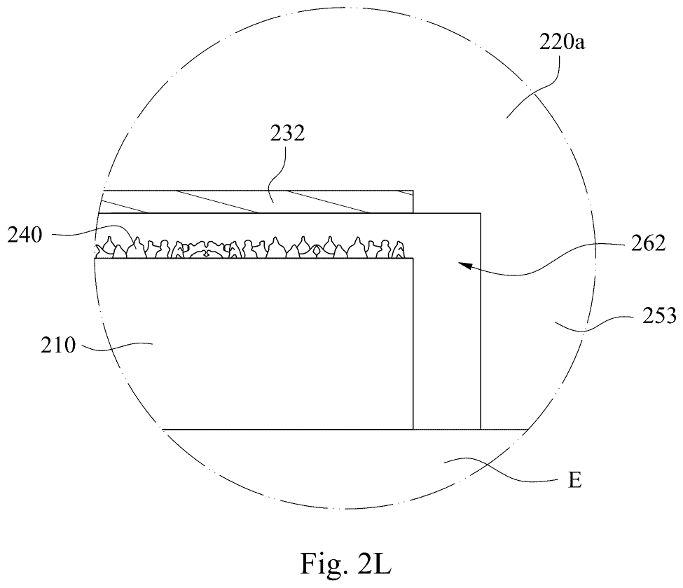

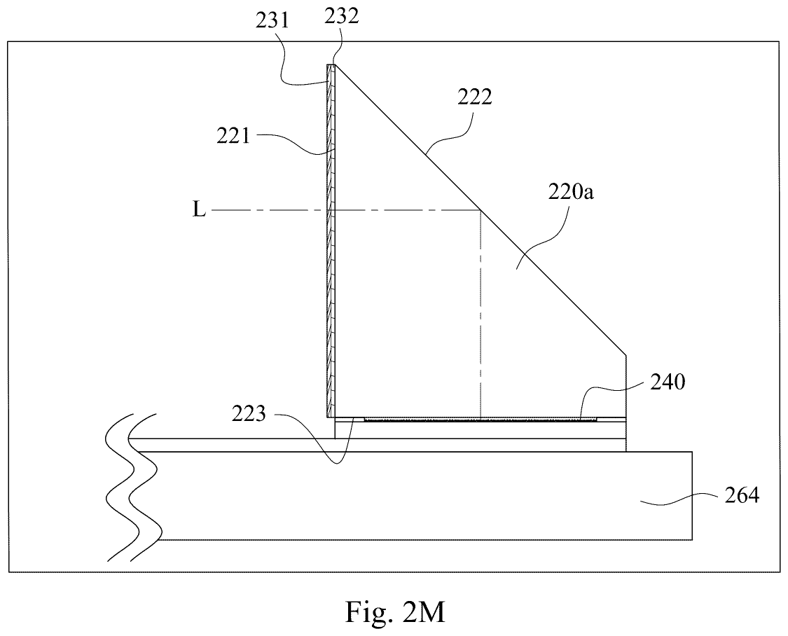

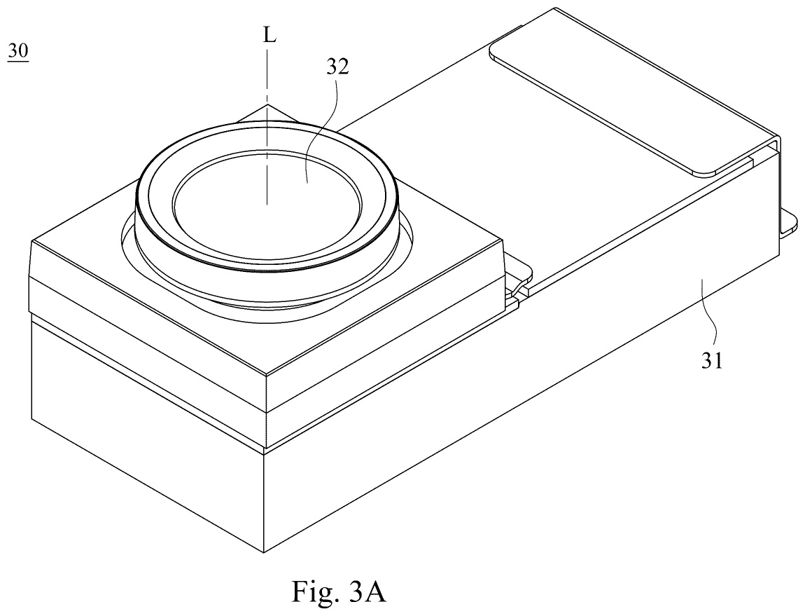

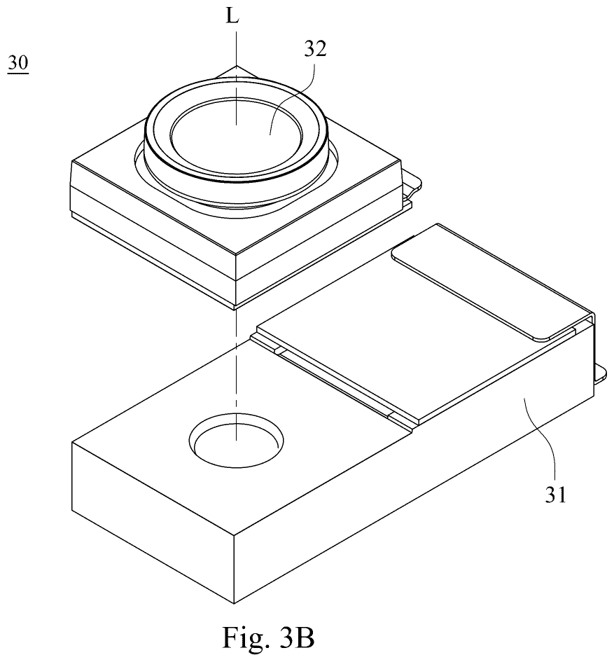

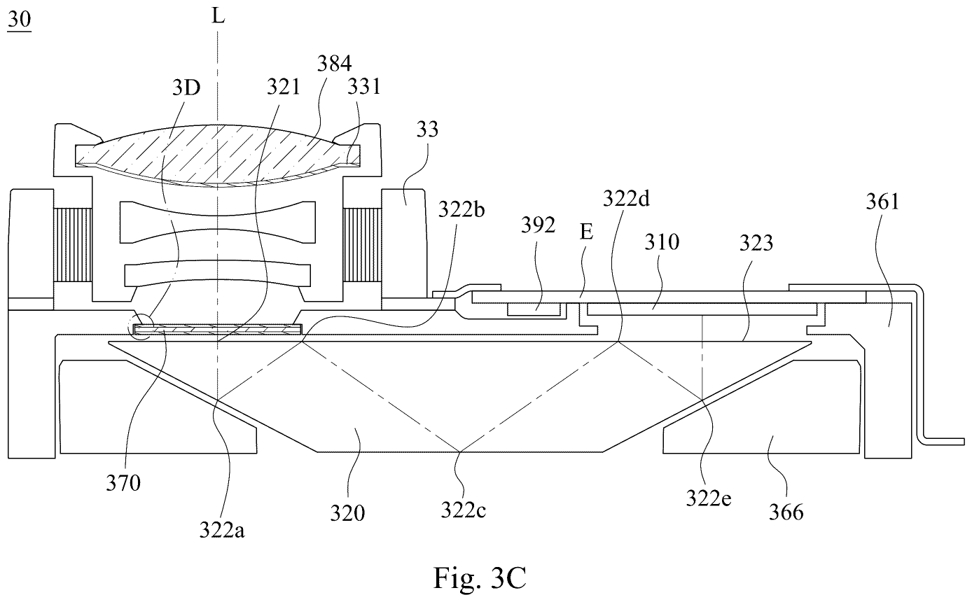

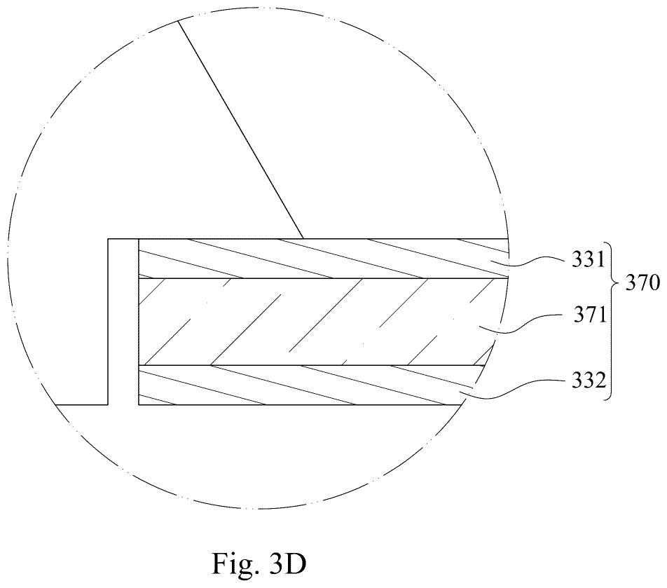

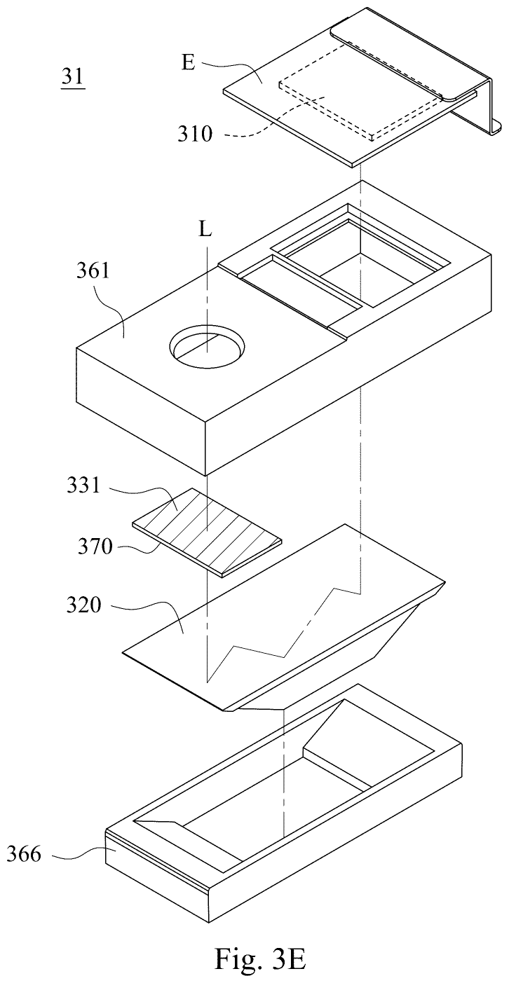

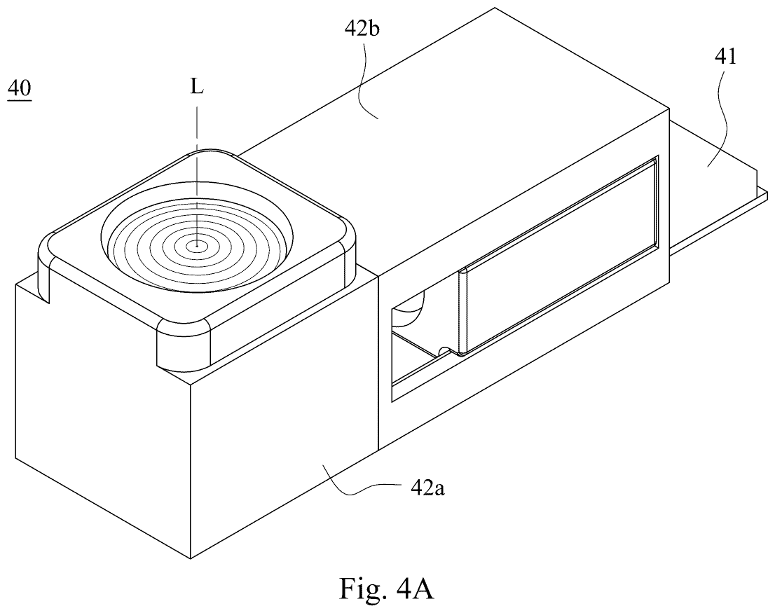

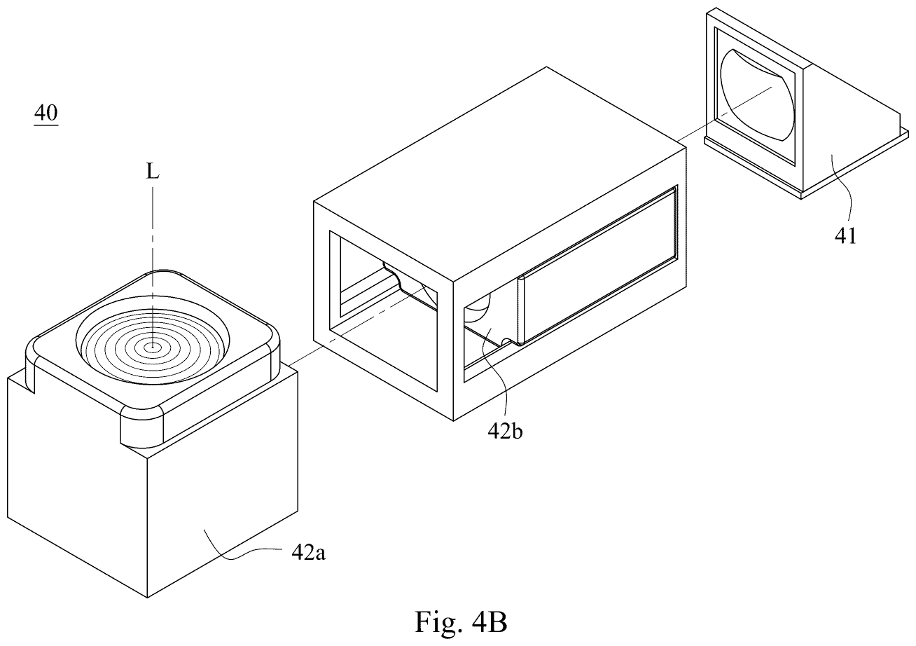

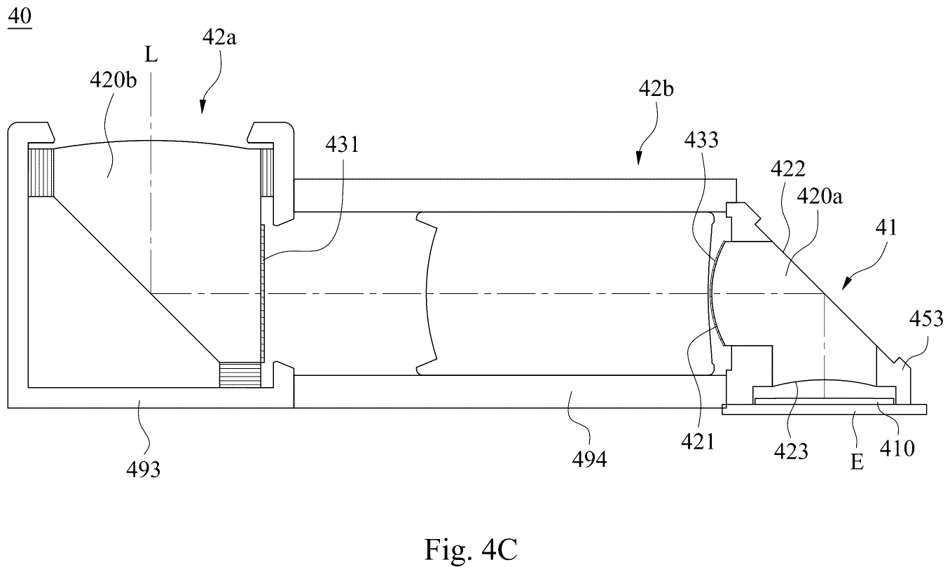

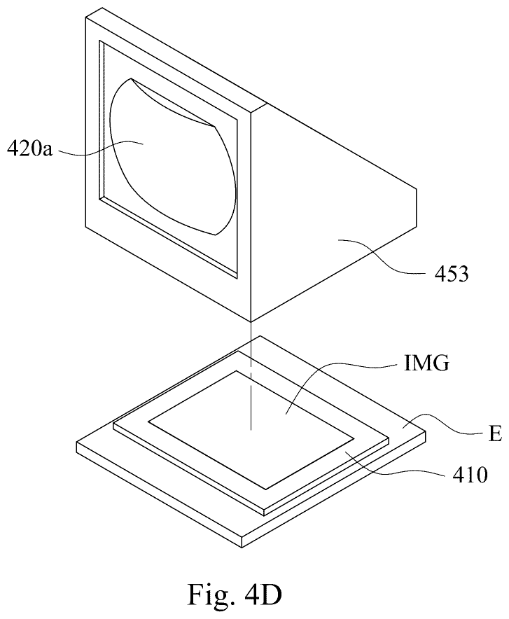

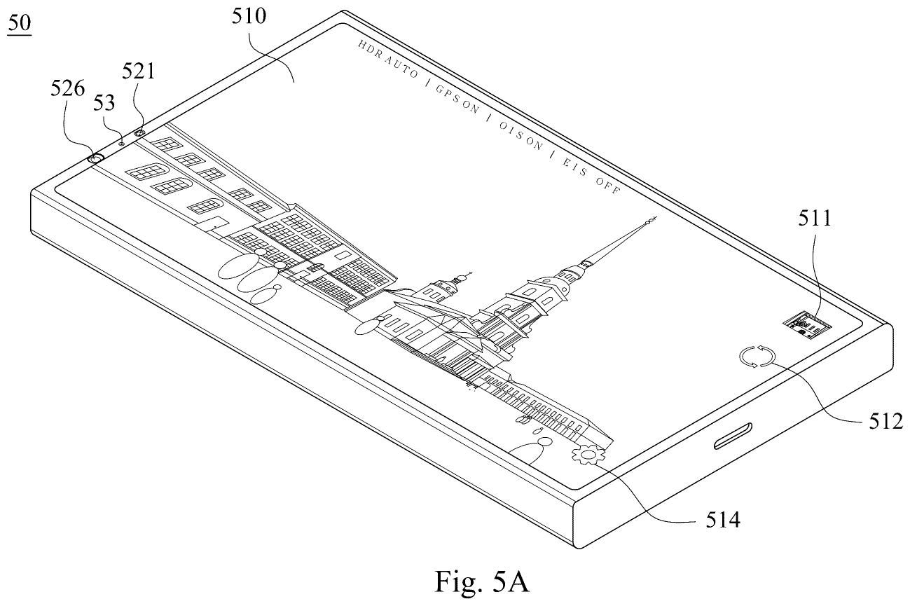

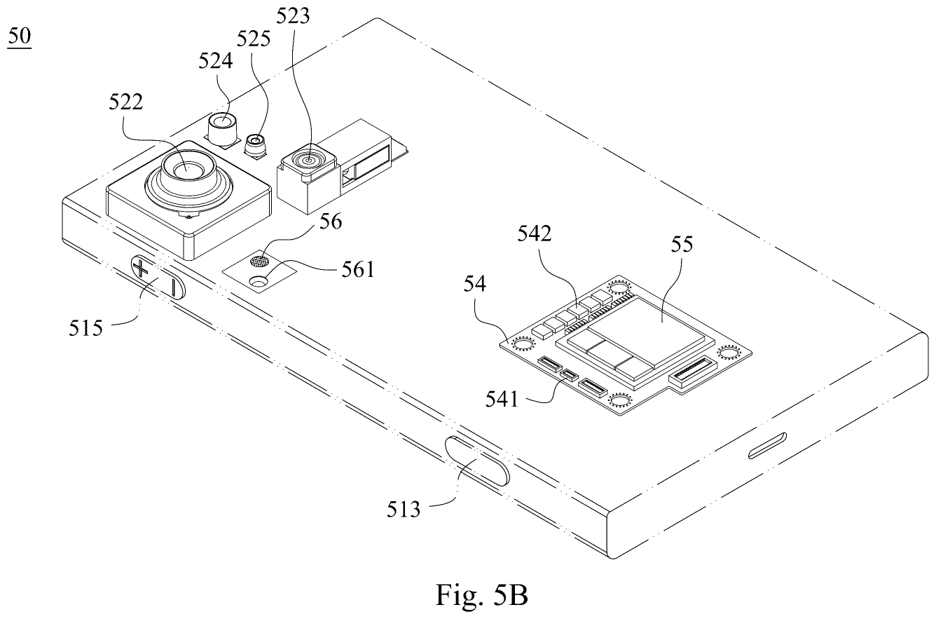

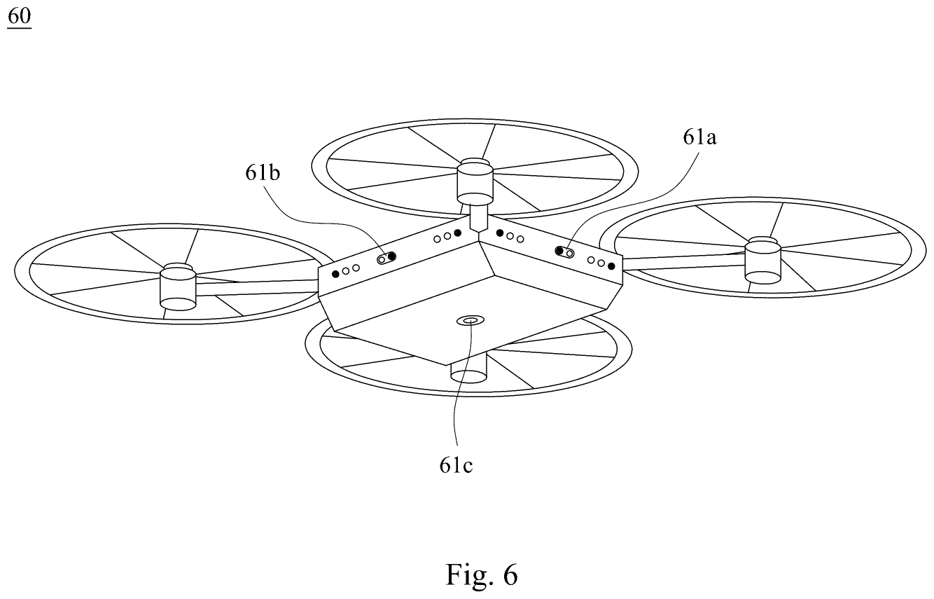

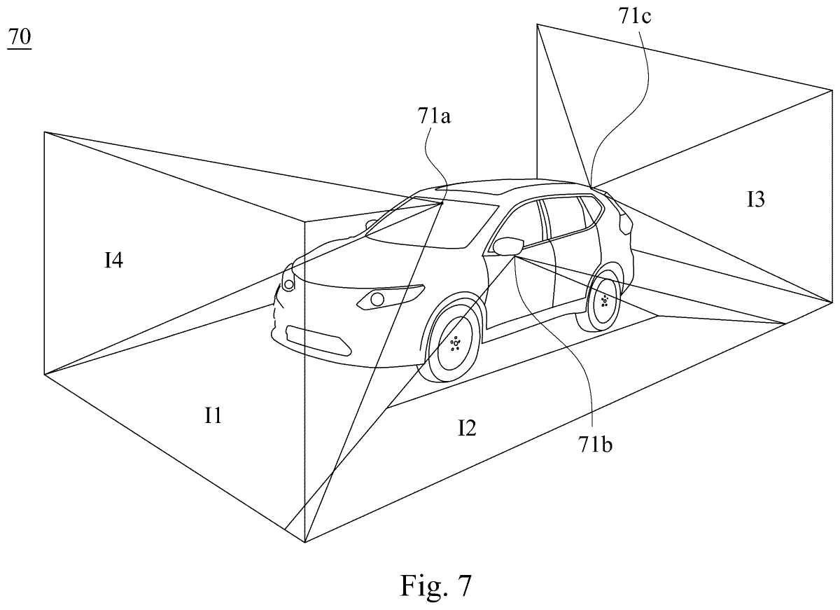

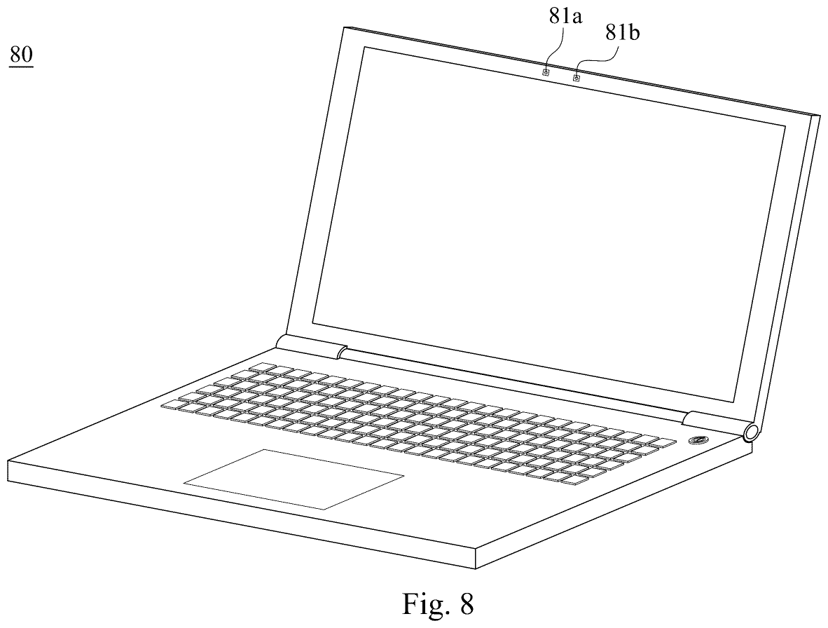

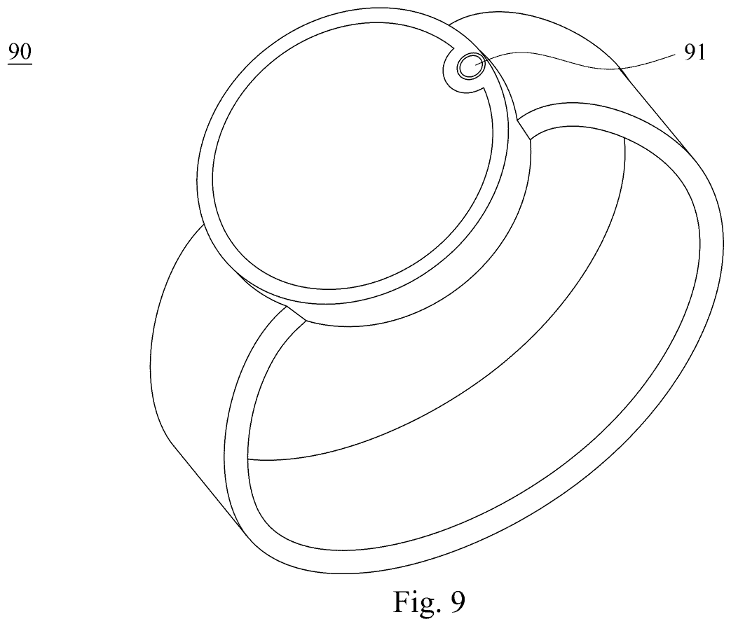

FIG. 1J is a cross-sectional view along line 1J-1J of the prism according to the 3rd example of the 1st embodiment of FIG. 11.

FIG. 1K is a three-dimensional schematic view of the prism according to the 4th example of the 1st embodiment of FIG. 1A.

FIG. 1L is a schematic view of the prism according to the 4th example of the 1st embodiment of FIG. 1K.

FIG. 1M is a cross-sectional view along line 1M-1M of the prism according to the 4th example of the 1st embodiment of FIG. 1L.

FIG. 1N is a three-dimensional schematic view of the prism according to the 5th example of the 1st embodiment of FIG. 1A.

FIG. 1O is a schematic view of the prism according to the 5th example of the 1st embodiment of FIG. 1N.

FIG. 1P is a cross-sectional view along line 1P-1P of the prism according to the 5th example of the 1st embodiment of FIG. 1O.

FIG. 1Q is a three-dimensional schematic view of the prism according to the 6th example of the 1st embodiment of FIG. 1A.

FIG. 1R is a schematic view of the prism according to the 6th example of the 1st embodiment of FIG. 1Q.

FIG. 1S is a three-dimensional schematic view of the prism according to the 7th example of the 1st embodiment of FIG. 1A.

FIG. 1T is a schematic view of the prism according to the 7th example of the 1st embodiment of FIG. 1S.

FIG. 1U shows the reflectances of the optical multilayer deposition structure layer according to the 1st embodiment of FIG. 1A.

FIG. 1V shows the transmittances of the filter according to the 1st embodiment of FIG. 1A.

FIG. 1W shows the reflectances of the nano-rough surface according to the 1st embodiment of FIG. 1A.

FIG. 1X shows the transmittances of the imaging lens assembly according to the 1st embodiment of FIG. 1A.

FIG. 1Y shows the transmittances of the lens elements according to the 1st embodiment of FIG. 1A.

FIG. 2A is a three-dimensional schematic view of a camera module according to the 2nd embodiment of the present disclosure.

FIG. 2B is a partial cross-sectional view of the camera module according to the 2nd embodiment of FIG. 2A.

FIG. 2C is a cross-sectional view of the camera module according to the 1st example of the 2nd embodiment of FIG. 2A.

FIG. 2D is a partial enlarged view of the camera module according to the 1st example of the 2nd embodiment of FIG. 2C.

FIG. 2E is another partial enlarged view of the camera module according to the 1st example of the 2nd embodiment of FIG. 2C.

FIG. 2F is a partial schematic view of the camera module according to the 2nd example of the 2nd embodiment of FIG. 2A.

FIG. 2G is a partial enlarged view of the camera module according to the 2nd example of the 2nd embodiment of FIG. 2F.

FIG. 2H is a partial schematic view of the camera module according to the 3rd example of the 2nd embodiment of FIG. 2A.

FIG. 21 is a partial schematic view of the camera module according to the 4th example of the 2nd embodiment of FIG. 2A.

FIG. 2J is a partial enlarged view of the camera module according to the 4th example of the 2nd embodiment of FIG. 21.

FIG. 2K is a partial schematic view of the camera module according to the 5th example of the 2nd embodiment of FIG. 2A.

FIG. 2L is a partial enlarged view of the camera module according to the 5th example of the 2nd embodiment of FIG. 2K.

FIG. 2M is a partial schematic view of the camera module according to the 6th example of the 2nd embodiment of FIG. 2A.

FIG. 3A is a three-dimensional schematic view of a camera module according to the 3rd embodiment of the present disclosure.

FIG. 3B is an exploded view of the camera module according to the 3rd embodiment of FIG. 3A.

FIG. 3C is a cross-sectional view of the camera module according to the 3rd embodiment of FIG. 3A.

FIG. 3D is a partial enlarged view of the camera module according to the 3rd embodiment of FIG. 3C.

FIG. 3E is an exploded view of the image sensor module according to the 3rd embodiment of FIG. 3A.

FIG. 4A is a three-dimensional schematic view of a camera module according to the 4th embodiment of the present disclosure.

FIG. 4B is an exploded view of the camera module according to the 4th embodiment of FIG. 4A.

FIG. 4C is a cross-sectional view of the camera module according to the 4th embodiment of FIG. 4A.

FIG. 4D is an exploded view of the image sensor module according to the 4th embodiment of FIG. 4A.

FIG. 5A is a schematic view of an electronic device according to the 5th embodiment of the present disclosure.

FIG. 5B is another schematic view of the electronic device according to the 5th embodiment of FIG. 5A.

FIG. 6 is a schematic view of an electronic device according to the 6th embodiment of the present disclosure disposed on an unmanned aerial vehicle.

FIG. 7 is a schematic view of an electronic device according to the 7th embodiment of the present disclosure disposed on a vehicle.

FIG. 8 is a schematic view of an electronic device according to the 8th embodiment of the present disclosure disposed on a computer.

FIG. 9 is a schematic view of an electronic device according to the 9th embodiment of the present disclosure disposed on a wearable device.

### DETAILED DESCRIPTION

The present disclosure provides an image sensor module having a light path, and including an image sensor, a reflecting element, an optical multilayer deposition structure layer and a nano-rough surface. The image sensor corresponds to the light path. The reflecting element faces towards and is adjacent to the image sensor, and the reflecting element is configured to fold the light path. The optical multilayer deposition structure layer is farther away from the image sensor than the reflecting element away from the image sensor along the light path, and a reflectance of the optical multilayer deposition structure layer corresponding to light with a wavelength from 450 nm to 600 nm is less than or equal to 10%. The nano-rough surface is disposed on one side of the image sensor facing towards the reflecting element, and the nano-rough surface includes a plurality of nano-protruding structures. Shapes of the nano-protruding structures are irregular, and the nano-protruding structures are arranged adjacent to each other. A width of each of the nano-protruding structures is smaller than or equal to 300 nm, and a height of each of the nano-protruding structures is smaller than or equal to 350 nm. A reflectance of the nano-rough surface corresponds to a reflectance of the optical multilayer deposition structure layer. When a wavelength with a reflectance of the optical multilayer deposition structure layer being 50% is R50, a maximum reflectance of the nano-rough surface corresponding to a wavelength from 450 nm to R50 is less than or equal to 0.49%, and the following condition is satisfied: 600 nm≤R50≤720 nm.

Specifically, by the arrangement of the reflecting element, the nano-rough surface and the optical multilayer deposition structure layer on the light path, the advantages, such as effectively improving color contrast, avoiding glare and shortening the height of the camera module, can be achieved. Therefore, the capacity utilization rate can be increased. Further, the present disclosure can improve the problem of glare generated by infrared light on the catadioptrics telephoto lens assembly.

By the arrangement of the optical multilayer deposition structure layer being farther away from the nano-rough surface than the reflecting element away from the nano-rough surface, glare formed by the reflection of the optical multilayer deposition structure layer and an image sensing surface can be avoided. Therefore, the reduction of the optical quality can be avoided, and the thickness of the optical multilayer deposition structure layer in a direction perpendicular to the image sensing surface can be reduced so as to increase the capacity utilization rate.

Further, light in a visible range can pass through the optical multilayer deposition structure layer, and infrared light and ultraviolet light can be reflected by the optical multilayer deposition structure layer. Therefore, the light filtering functionality can be achieved. The nano-rough surface can optimize the light transmission rate of the optical multilayer deposition structure layer, so that light reflected on the image sensing surface can be significantly reduced, and the proportion of received visible light can be increased.

The optical multilayer deposition structure layer is multi-layered, and a layer number thereof can be greater than or equal to 10. A high-rise optical multilayer deposition structure layer can be formed by stacking multiple sets of coatings, and layers of the optical multilayer deposition structure layer adjacent to each other have different refractive indices. Therefore, different reflectances in different frequencies of light can be provided. By stacking the layers with higher refractive indices and lower refractive indices with each other, light with a wavelength below 400 nm and light with a wavelength above 700 nm can have higher reflectances. Therefore, the effect of light filtering can be achieved. Further, the layer number can be greater than or equal to 36. Furthermore, the layer number can be greater than or equal to 72.

Further, the nano-rough surface can be manufactured by a nanoimprint lithography method, an etching method, an epitaxy method, etc., but the present disclosure is not limited thereto.

The reflecting element can include a prism, wherein the prism includes a light incident surface, at least one reflecting surface and a light exiting surface along the light path, and the light exiting surface faces towards and is adjacent to the nano-rough surface. Specifically, it is favorable for increasing the yield rate by reducing the assembly tolerance by the prism. Further, by the arrangement of the light exiting surface, the air gap can be further closed, so that great seal ability can be achieved.

The optical multilayer deposition structure layer can be disposed on the light incident surface. Therefore, the surface reflection generated by the optical multilayer deposition structure layer and the light incident surface can be avoided. Further, the optical multilayer deposition structure layer can be directly disposed on the light incident surface, and the aforementioned structure can be formed by adhering a filter to the prism, but the present disclosure is not limited thereto.

The prism can be a red light absorbing element, wherein the red light absorbing element can be a blue glass. Therefore, the interference of red light on other photosensitive pixels can be reduced, and the optical quality can be further enhanced.

At least one of the light incident surface, the reflecting surface and the light exiting surface of the prism can include an aspheric surface, and the aspheric surface is disposed corresponding to the light path. Therefore, the optical quality after passing through the optical multilayer deposition structure layer can be further enhanced.

The prism can further include a plurality of concave structures. The concave structures are arranged adjacent to each other and gradually tapered along a direction close to the light path, and each two of the concave structures adjacent to each other form a tip. A distance of each two of the tips adjacent to each other can be between 0.3 mm to 2.9 mm. Therefore, glare generated by light reflected by a wall surface of the prism can be avoided.

The prism can be a glass element, wherein the prism can further include a gate trace, and the prism is injection molded by the gate trace. Specifically, a material of the prism can be a transparent glass, a red light absorbing glass, etc., but the present disclosure is not limited thereto.

The prism can further include an edge surface, wherein the gate trace extends from the edge surface towards a direction away from the light path, and the gate trace is gradually broadened along a direction close to the edge surface. Therefore, glare generated at a cut of the gate trace can be avoided. In detail, the gate trace can include a rounded surface, wherein the rounded surface is connected to the edge surface, so that the formability can be enhanced.

The reflecting element can include a reflecting mirror, wherein the reflecting mirror is configured to fold the light path. By reducing the weight of the reflecting element, the weight of the image sensor module can be reduced, and the energy and time consumed in driving the reflecting element can be indirectly reduced.

The reflecting element can further include a frame, wherein the frame and the reflecting mirror are integrally formed by an insert molding method. Therefore, the assembly tolerance can be reduced, and the assembling process can be simplified.

The reflecting element can further include a nano-rough surface, wherein the nano-rough surface is disposed on at least one part of the reflecting mirror and the frame. Therefore, the reflection generated at a substrate surface of the reflecting mirror can be reduced to avoid ghosting, and glare caused by the reflection of the frame can be reduced.

The image sensor module can further include a holder element and an air gap. The holder element is configured to cover on the image sensor, wherein the reflecting element is disposed on the holder element. The air gap is formed between the reflecting element and the image sensor, the holder element surrounds the air gap, and the nano-rough surface and the air gap at least partially overlap on the light path. Therefore, the image sensing surface being contaminated during the assembling process can be avoided.

The nano-rough surface can extend from an image sensing surface towards the holder element, and the nano-rough surface is disposed on at least one part of the holder element. Therefore, glare generated by light reflected by the holder element can be avoided.

The reflecting element can include a holder portion, wherein the holder portion and the image sensor are relatively fixed to each other. The image sensor module can further include an air gap, wherein the air gap is formed between the reflecting element and the image sensor. The holder portion surrounds the air gap, and the nano-rough surface and the air gap at least partially overlap on the light path. By the arrangement that the reflecting element and the holder portion are integrally formed, the assembling process can be simplified, and the assembly tolerance can be reduced. Therefore, the optical quality can be enhanced. Further, the method for integrally forming the reflecting element and the holder portion can be achieved by an injection molding method, the insert molding method, etc., but the present disclosure is not limited thereto.

The image sensor module can further include an infrared light-absorbing coating layer, wherein the infrared light absorbing coating layer is disposed on the reflecting element, and a thickness of the infrared light absorbing coating layer can be between 900 nm to 5 μm. Therefore, the image quality affected by the remaining infrared light after passing through the optical multilayer deposition structure layer can be avoided. Further, when the infrared light absorbing coating layer is disposed on the reflecting surface, it is equivalent to passing through the infrared light absorbing coating layer twice. Therefore, the thickness of the coating layer can be reduced.

The image sensor module can further include a filter, wherein the filter can include a red light absorbing board, and the optical multilayer deposition structure layer is disposed on the red light absorbing board. By the arrangement of the red light absorbing board, the interference of red light on other photosensitive pixels can be reduced, and the optical quality can be further enhanced. Specifically, it is favorable for ensuring the production possibility by modularizing the filter for improving the assembling process.

The image sensor can include a plurality of pixel units, wherein a pixel size of each of the pixel units can be between 400 nm to 2000 nm. Any one of the pixel units includes a microlens, and the nano-rough surface is disposed on the microlens of any one of the pixel units. By enhancing the light collecting effect of the pixel units, the optical quality of the edge can be improved. Further, an intermediate layer can be further included between the nano-rough surface and the microlens. Therefore, the adhesive properties can be enhanced.

Each of the aforementioned features of the image sensor module of the present disclosure can be utilized in numerous combinations so as to achieve the corresponding functionality.

The present disclosure further provides a camera module including the aforementioned image sensor module and an imaging lens assembly, wherein the imaging lens assembly is disposed on an object side of the image sensor module along the light path, and the optical multilayer deposition structure layer can be disposed on an object side of the reflecting element.

The camera module can further include an object-side reflecting element, wherein the object-side reflecting element is disposed on the object side of the image sensor module, and the optical multilayer deposition structure layer is disposed on the object-side reflecting element. Therefore, it is favorable for avoiding glare generated by non-imaging light entering the camera module.

The imaging lens assembly can include an object-side lens set, wherein the object-side lens set is disposed on an object side of the object-side reflecting element. By controlling light which is passing through the optical multilayer deposition structure layer, the benefits thereof can be enhanced.

The imaging lens assembly can include an image-side lens set, wherein the image-side lens set is disposed between the object-side reflecting element and the image sensor module, and the optical multilayer deposition structure layer is disposed between the image-side lens set and the reflecting element. By optimizing light which is passing through the optical multilayer deposition structure layer, the optical quality can be enhanced.

The camera module can further include an object-side reflecting element, wherein the object-side reflecting element is disposed on the object side of the reflecting element. The object-side reflecting element can include an infrared light-absorbing coating layer, the light path passes through the infrared light-absorbing coating layer, and a thickness of the infrared light absorbing coating layer can be between 900 nm to 5 μm. Further, the object-side reflecting element can include the infrared light-absorbing coating layer, wherein the infrared light absorbing coating layer can cooperate with the optical multilayer deposition structure layer. Therefore, light in an infrared wavelength range from entering the image sensing surface can be avoided, thus the optical quality can be enhanced.

The imaging lens assembly can include a plurality of lens elements, wherein the lens elements are sequentially arranged along the light path, and the optical multilayer deposition structure layer is disposed on one of the lens elements. In detail, a material of the lens elements can be an infrared light absorbing material so as to further filter infrared light.

The imaging lens assembly can further include a lens set, wherein the lens set and the reflecting element are relatively fixed to each other, and the optical multilayer deposition structure layer is disposed on the lens set. Therefore, the risk generated by the displacement of the optical multilayer deposition structure layer can be reduced.

The imaging lens assembly can further include an optical absorbing lens element, wherein an absorption peak value of the optical absorbing lens element can be between 600 nm to 800 nm. By the cooperation between the optical absorbing lens element and the optical multilayer deposition structure layer, it is favorable for correcting chromatic aberration generated by the optical multilayer deposition structure layer so as to further enhance the effect of light filtering. In detail, the optical multilayer deposition structure layer can be further disposed on the optical absorbing lens element.

The image sensor module can further include a sub-optical multilayer deposition structure layer, wherein the sub-optical multilayer deposition structure layer is disposed on the reflecting element. A reflectance of the sub-optical multilayer deposition structure layer corresponding to light with a wavelength from 450 nm to 550 nm can be less than or equal to 10%. When a wavelength with a reflectance of the sub-optical multilayer deposition structure layer being 50% is R50′, the following condition can be satisfied: 600 nm≤R50′≤720 nm. Thus, the optical quality can be ensured by filtering incident light twice. Specifically, the sub-optical multilayer deposition structure layer can be further disposed on the filter.

An average transmittance of the imaging lens assembly corresponding to light with a wavelength from 700 nm to 800 nm can be less than or equal to 5%, and a transmittance of the imaging lens assembly corresponding to light with a maximum transmittance wavelength from 400 nm to 800 nm can be greater than or equal to 82%. By the imaging lens assembly having the light filtering functionality, the space of using conventional filter can be saved, and the volume of the camera module can be further reduced.

The width of each of the nano-protruding structures can be smaller than or equal to 250 nm, and the height of each of the nano-protruding structures can be smaller than or equal to 250 nm, wherein a layer number of the optical multilayer deposition structure layer can be greater than 30. The imaging lens assembly can include an optical absorbing lens element, and an absorbing peak value of the optical absorbing lens element can be between 650 nm to 750 nm. The average transmittance of the imaging lens assembly corresponding to the light with the wavelength from 700 nm to 800 nm can be less than or equal to 1%, and the transmittance of the imaging lens assembly corresponding to the light with the maximum transmittance wavelength from 400 nm to 800 nm can be greater than or equal to 85%. When a wavelength with the reflectance of the optical multilayer deposition structure layer being 50% is R50, a maximum reflectance of the nano-rough surface corresponding to a wavelength from 450 nm to R50 can be less than or equal to 0.2%, and the following condition can be satisfied: 650 nm≤R50≤700 nm.

Each of the aforementioned features of the camera module of the present disclosure can be utilized in numerous combinations so as to achieve the corresponding functionality.

The present disclosure further provides an electronic device including the aforementioned camera module.

According to the aforementioned embodiment, the specific embodiments, examples and reference drawings thereof are given below so as to describe the present disclosure in detail.

<1st embodiment>

FIG. 1A is a three-dimensional schematic view of a camera module 10 according to the 1st embodiment of the present disclosure. FIG. 1B is a cross-sectional view of the camera module 10 according to the 1st embodiment of FIG. 1A. FIG. 1C is another cross-sectional view of the camera module 10 according to the 1st embodiment of FIG. 1A. As shown in FIG. 1A to FIG. 1C, the camera module 10 includes an image sensor module 11, an imaging lens assembly (its reference numeral is omitted) and an imaging lens carrier 13 (labelled in FIG. 1E). The imaging lens assembly is disposed on an object side of the image sensor module 11 along a light path L, and the imaging lens carrier 13 is used to carry the imaging lens assembly.

FIG. 1D is a scanning electron microscope image of an image sensor 110 and a nano-rough surface 140 according to the 1st embodiment of FIG. 1A. FIG. 1E is a partial schematic view of the camera module 10 according to the 1st example of the 1st embodiment of FIG. 1A. FIG. 1F is a partial enlarged view of the image sensor module 11 according to the 1st example of the 1st embodiment of FIG. 1E. As shown in FIG. 1B to FIG. 1F, the image sensor module 11 has the light path L, and includes the image sensor 110, a reflecting element 120a, an optical multilayer deposition structure layer 131 and the nano-rough surface 140. The image sensor 110 corresponds to the light path L. The reflecting element 120a faces towards and is adjacent to the image sensor 110, and the reflecting element 120a is configured to fold the light path L. The optical multilayer deposition structure layer 131 is farther away from the image sensor 110 than the reflecting element 120a away from the image sensor 110 along the light path L, and the optical multilayer deposition structure layer 131 is disposed on an object side of the reflecting element 120a. The nano-rough surface 140 is disposed on one side of the image sensor 110 facing towards the reflecting element 120a, and the nano-rough surface 140 includes a plurality of nano-protruding structures 141. Shapes of the nano-protruding structures 141 are irregular, and the nano-protruding structures 141 are arranged adjacent to each other.

By the arrangement of the optical multilayer deposition structure layer 131 being farther away from the nano-rough surface 140 than the reflecting element 120a away from the nano-rough surface 140 along the light path L, glare formed by the reflection of the optical multilayer deposition structure layer 131 and an image sensing surface IMG of the image sensor 110 can be avoided. Therefore, the reduction of the optical quality can be avoided, and the thickness of the optical multilayer deposition structure layer 131 in a direction perpendicular to the image sensing surface IMG can be reduced so as to increase the capacity utilization rate.

In detail, light in a visible range can pass through the optical multilayer deposition structure layer 131, and infrared light and ultraviolet light can be reflected by the optical multilayer deposition structure layer 131, or infrared light or ultraviolet light can be reflected by the optical multilayer deposition structure layer 131. Therefore, the light filtering functionality can be achieved. The nano-rough surface 140 can optimize the light transmission rate of the optical multilayer deposition structure layer 131, so that light reflected on the image sensing surface IMG can be significantly reduced, and the proportion of received visible light can be increased.

The optical multilayer deposition structure layer 131 is multi-layered, and a layer number of the optical multilayer deposition structure layer 131 can be greater than or equal to 10, wherein the high-rise optical multilayer deposition structure layer 131 can be formed by stacking multiple sets of coatings. Further, the layer number can be greater than or equal to 30. Further, the layer number can be greater than or equal to 36. Further, the layer number can be greater than or equal to 72. Furthermore, the nano-rough surface 140 can be manufactured by the nanoimprint lithography method, the etching method, the epitaxy method, etc., but the present disclosure is not limited thereto.

Table 1 shows the refractive index classification and thickness values of the optical multilayer deposition structure layer 131 in the 1st embodiment, wherein the optical multilayer deposition structure layer 131 is formed by stacking two sets of coatings, but the present disclosure is not limited thereto. As shown in Table 1, layers of the optical multilayer deposition structure layer 131 adjacent to each other are made of materials with different refractive indices. Therefore, different reflectances in different frequencies of light can be provided. Further, in refractive index of Table 1, “H” and “L” represent a “high refractive index material” and a “low refractive index material”, wherein the high refractive index material is silicon dioxide, and the low refractive index material is magnesium fluoride.

TABLE 1

| | | Refractive | Thickness |
|---|---|---|---|
| Group | Layer | index | (nm) |
| 1 | 1 | H | 2 |
| | 2 | L | 253 |
| | 3 | H | 3 |
| | 4 | L | 63 |
| | 5 | H | 0.5 |
| | 6 | L | 214 |
| | 7 | H | 17 |
| | 8 | L | 38 |
| | 9 | H | 83 |
| | 10 | L | 6 |
| | 11 | H | 38 |
| | 12 | L | 194 |
| | 13 | H | 118 |
| | 14 | L | 193 |
| | 15 | H | 119 |
| | 16 | L | 193 |
| | 17 | H | 119 |
| | 18 | L | 196 |
| | 19 | H | 120 |
| | 20 | L | 193 |
| | 21 | H | 118 |
| | 22 | L | 194 |
| | 23 | H | 117 |
| | 24 | L | 186 |
| | 25 | H | 106 |
| | 26 | L | 165 |
| | 27 | H | 100 |
| | 28 | L | 167 |
| | 29 | H | 92 |
| | 30 | L | 156 |
| | 31 | H | 93 |
| | 32 | L | 150 |
| | 33 | H | 96 |
| | 34 | L | 108 |
| 2 | 35 | H | 4 |
| | 36 | L | 35 |
| | 37 | H | 91 |
| | 38 | L | 158 |
| | 39 | H | 92 |
| | 40 | L | 153 |
| | 41 | H | 99 |
| | 42 | L | 32 |
| | 43 | H | 19 |
| | 44 | L | 36 |
| | 45 | H | 107 |
| | 46 | L | 36 |
| | 47 | H | 17 |
| | 48 | L | 41 |
| | 49 | H | 108 |
| | 50 | L | 34 |
| | 51 | H | 17 |
| | 52 | L | 35 |
| | 53 | H | 110 |
| | 54 | L | 28 |
| | 55 | H | 19 |
| | 56 | L | 24 |
| | 57 | H | 110 |
| | 58 | L | 35 |
| | 59 | H | 20 |
| | 60 | L | 28 |
| | 61 | H | 109 |
| | 62 | L | 37 |
| | 63 | H | 22 |
| | 64 | L | 26 |
| | 65 | H | 103 |
| | 66 | L | 39 |
| | 67 | H | 21 |
| | 68 | L | 30 |
| | 69 | H | 88 |
| | 70 | L | 78 |

As shown in FIG. 1B and FIG. 1C, the camera module 10 can further include an object-side reflecting element 120b, wherein the object-side reflecting element 120b is disposed on an object side of the image sensor module 11, and the optical multilayer deposition structure layer 131 is disposed on the object-side reflecting element 120b. Further, the object-side reflecting element 120b is disposed on the object side of the reflecting element 120a. Therefore, it is favorable for avoiding glare generated by non-imaging light entering the camera module 10.

As shown in FIG. 1A to FIG. 1C, the camera module 10 can further include a base BS, wherein the object-side reflecting element 120b can be moved relative to the base BS. Therefore, the optical stabilization function can be achieved.

The camera module 10 can further include a circuit E, wherein the circuit E is disposed on one side of the image sensor 110.

As shown in FIG. 1B, FIG. 1C and FIG. 1E, the imaging lens assembly can include an image-side lens set 181 and an object-side lens set 182. The image-side lens set 181 includes two lens element groups 181a, 181b, wherein the image-side lens set 181 is disposed between the object-side reflecting element 120b and the image sensor module 11. The optical multilayer deposition structure layer 131 is disposed between the image-side lens set 181 and the reflecting element 120a, and the object-side lens set 182 is disposed on an object side of the object-side reflecting element 120b. By the arrangement of the image-side lens set 181, light passing through the optical multilayer deposition structure layer 131 can be optimized, so that the optical quality can be enhanced. Further, light passing through the optical multilayer deposition structure layer 131 can be controlled by the object-side lens set 182, so that the benefits thereof can be enhanced.

Further, the lens element group 181b of the image-side lens set 181 and the object-side lens set 182 are fixedly disposed, and the lens element group 181a of the image-side lens set 181 is movably disposed.

The imaging lens assembly can include a plurality of lens elements LE, wherein the lens elements LE are sequentially arranged along the light path L. In detail, a material of the lens elements LE can be an infrared light absorbing material so as to further filter infrared light.

As shown in FIG. 1E and FIG. 1F, the image sensor module 11 can further include a holder element 161 and an air gap 162. The holder element 161 is configured to cover on the image sensor 110, and the reflecting element 120a is disposed on the holder element 161. The air gap 162 is formed between the reflecting element 120a and the image sensor 110, the holder element 161 surrounds the air gap 162, and the nano-rough surface 140 and the air gap 162 at least partially overlap on the light path L. Therefore, the image sensing surface IMG being contaminated during the assembling process can be avoided.

Further, the nano-rough surface 140 extends from the image sensing surface IMG towards the holder element 161, and the nano-rough surface 140 is disposed on at least one part of the holder element 161, wherein the nano-rough surface 140 is further disposed on an inner sidewall 163 of the holder element 161. Therefore, glare generated by light reflected by holder element 161 can be avoided.

As shown in FIG. 1D and FIG. 1E, the image sensor module 11 can further include an infrared light absorbing coating layer 132 and a filter 170, wherein the filter 170 includes a red light absorbing board 171, and the optical multilayer deposition structure layer 131 and the infrared light absorbing coating layer 132 are disposed on the red light absorbing board 171. By the arrangement of the red light absorbing board 171, the interference of red light on other photosensitive pixels can be reduced, and the optical quality can be further enhanced. Further, by the arrangement of the infrared light absorbing coating layer 132, the image quality affected by the remaining infrared light after passing through the optical multilayer deposition structure layer 131 can be avoided. Specifically, it is favorable for ensuring the production possibility by modularizing the filter 170 for improving the assembling process.

As shown in FIG. 1E and FIG. 1F, the reflecting element 120a can include a prism (its reference numeral is omitted), wherein the prism includes a light incident surface 121, at least one reflecting surface 122 and a light exiting surface 123 along the light path L. The light exiting surface 123 faces towards and is adjacent to the nano-rough surface 140 and the image sensing surface IMG. Specifically, it is favorable for increasing the yield rate by reducing the assembly tolerance by the prism. Further, by the arrangement of light exiting surface 123, the air gap 162 can be further closed, so that great seal ability can be achieved.

As shown in FIG. 1D, the image sensor 110 can include a plurality of pixel units 111, wherein any one of the pixel units 111 includes a microlens 112, and the nano-rough surface 140 is disposed on the microlens 112 of any one of the pixel units 111. By enhancing the light collecting effect of the pixel units 111, the optical quality of the edge can be improved. Further, an intermediate layer (its reference numeral is omitted) can be further included between the nano-rough surface 140 and the microlens 112. Therefore, the adhesive properties can be enhanced.

In detail, a width W1 of each of the nano-protruding structures 141 is 193 nm, a height H1 of each of the nano-protruding structures 141 is 137 nm, a pixel size W2 of each of the pixel units 111 is 800 nm, and a distance H2 between the nano-protruding structures 141 and an image sensor surface 110a is 240 nm.

FIG. 1G is a partial schematic view of the camera module 10 according to the 2nd example of the 1st embodiment of FIG. 1A. As shown in FIG. 1G, the infrared light absorbing coating layer 132 is disposed on a red light absorbing board 171, and the optical multilayer deposition structure layer 131 is disposed on one of the lens elements LE.

The lens element group 181b of the image-side lens set 181 and the reflecting element 120a are relatively fixed to each other, and the optical multilayer deposition structure layer 131 is disposed on the lens element group 181b of the image-side lens set 181. Therefore, the risk generated by the displacement of the optical multilayer deposition structure layer 131 can be reduced.

The image sensor module 11 can further include a sub-optical multilayer deposition structure layer 133, wherein the sub-optical multilayer deposition structure layer 133 is disposed on the reflecting element 120a. Thus, the optical quality can be ensured by filtering incident light twice. In detail, the sub-optical multilayer deposition structure layer 133 can be further disposed on the filter 170.

FIG. 1H is a three-dimensional schematic view of the prism according to the 3rd example of the 1st embodiment of FIG. 1A. FIG. 11 is a schematic view of the prism according to the 3rd example of the 1st embodiment of FIG. 1H. FIG. 1J is a cross-sectional view along line 1J-1J of the prism according to the 3rd example of the 1st embodiment of FIG. 11. As shown in FIG. 1H to FIG. 1J, the light incident surface 121 is disposed on a light incident side IS of the prism, and the light exiting surface 123 is disposed on a light exiting side ES of the prism.

As shown in FIG. 1J, the prism can further include a plurality of concave structures, wherein the concave structures are arranged adjacent to each other and gradually tapered along a direction close to the light path L, and each two of the concave structures adjacent to each other form a tip 124. Therefore, glare generated by light reflected by a wall surface of the prism can be avoided.

In the 3rd example of the 1st embodiment, distances of every each two of the tips 124 adjacent to each other are respectively SP1 and SP2, wherein the distance SP1 of two of the tips 124 adjacent to each other is 0.7 mm, and the distance SP2 of the other two of the tips 124 adjacent to each other is 0.99 mm.

FIG. 1K is a three-dimensional schematic view of the prism according to the 4th example of the 1st embodiment of FIG. 1A. FIG. 1L is a schematic view of the prism according to the 4th example of the 1st embodiment of FIG. 1K. FIG. 1M is a cross-sectional view along line 1M-1M of the prism according to the 4th example of the 1st embodiment of FIG. 1L. As shown in FIG. 1K to FIG. 1M, a distance of each two of the tips 124 adjacent to each other is SP, wherein the distance SP of each two of the tips 124 adjacent to each other is 0.7 mm.

FIG. 1N is a three-dimensional schematic view of the prism according to the 5th example of the 1st embodiment of FIG. 1A. FIG. 1O is a schematic view of the prism according to the 5th example of the 1st embodiment of FIG. 1N. FIG. 1P is a cross-sectional view along line 1P-1P of the prism according to the 5th example of the 1st embodiment of FIG. 1O. As shown in FIG. 1N to FIG. 1P, each of the light incident surface 121 and the light exiting surface 123 includes an aspheric surface, and the aspheric surface is disposed corresponding to the light path L. Therefore, the optical quality after passing through the optical multilayer deposition structure layer 131 can be further enhanced.

The prism can be a plastic prism, and the prism can further include a gate trace 125, wherein the prism is injection molded by the gate trace 125.

In the 5th example of the 1st embodiment, a distance of each two of the tips 124 adjacent to each other is SP, wherein the distance SP of each two of the tips 124 adjacent to each other is 1.4 mm.

FIG. 1Q is a three-dimensional schematic view of the prism according to the 6th example of the 1st embodiment of FIG. 1A. FIG. 1R is a schematic view of the prism according to the 6th example of the 1st embodiment of FIG. 1Q. As shown in FIG. 1Q and FIG. 1R, each of the light incident surface 121 and the light exiting surface 123 includes an aspheric surface, and the aspheric surface is disposed corresponding to the light path L.

FIG. 1S is a three-dimensional schematic view of the prism according to the 7th example of the 1st embodiment of FIG. 1A. FIG. 1T is a schematic view of the prism according to the 7th example of the 1st embodiment of FIG. 1S. As shown in FIG. 1S and FIG. 1T, each of the light incident surface 121 and the light exiting surface 123 includes an aspheric surface, and the aspheric surface is disposed corresponding to the light path L.

The prism can be a glass element, and the prism can further include a gate trace 125 and an edge surface 126, wherein the prism is injection molded by the gate trace 125. The gate trace 125 extends from the edge surface 126 towards a direction away from the light path L, and the gate trace 125 is gradually broadened along a direction close to the edge surface 126. Therefore, glare generated at a cut of the gate trace 125 can be avoided.

The gate trace 125 can include a rounded surface 127, wherein the rounded surface 127 is connected to the edge surface 126, so that the formability can be enhanced.

Specifically, a glass prism can be formed by a glass injection molding method, and the material of the prism can be the red light absorbing glass, but the present disclosure is not limited thereto. Therefore, the interference of red light on other photosensitive pixels can be reduced, and the optical quality can be further enhanced. Further, the prism can be a red light absorbing element, wherein the red light absorbing element can be a blue glass.

FIG. 1U shows the reflectances of the optical multilayer deposition structure layer 131 according to the 1st embodiment of FIG. 1A. As shown in FIG. 1U, a reflectance of the nano-rough surface 140 corresponds to a reflectance of the optical multilayer deposition structure layer 131. When a wavelength with a reflectance of the optical multilayer deposition structure layer being 50% is R50, the parameters satisfy the conditions as shown in Table 2. It should be mentioned that all of Sample a to Sample h can be applied to the 1st example to the 7th example of 1st embodiment. Further, in Sample a, by stacking the layers with higher refractive indices and lower refractive indices with each other, light with a wavelength below 400 nm and light with a wavelength above 700 nm can have higher reflectances. Therefore, the effect of light filtering can be achieved.

TABLE 2

| | Sample a | Sample b | Sample c | Sample d |
|---|---|---|---|---|
| R50 (nm) | 661 | 670 | 682 | 692 |
| | Sample e | Sample f | Sample g | Sample h |
| R50 (nm) | 701 | 664 | 672 | 681 |

FIG. 1V shows the transmittances of the filter 170 according to the 1st embodiment of FIG. 1A. As shown in FIG. 1V, both of Sample i and Sample ii can be applied to the 1st example to the 7th example of the 1st embodiment.

FIG. 1W shows the reflectances of the nano-rough surface 140 according to the 1st embodiment of FIG. 1A. As shown in FIG. 1W, all of Sample 1 to Sample 9 can be applied to the 1st example to the 7th example of the 1st embodiment.

FIG. 1X shows the transmittances of the imaging lens assembly according to the 1st embodiment of FIG. 1A. As shown in FIG. 1X, an average transmittance of the imaging lens assembly corresponding to light with the wavelength from 700 nm to 800 nm is 0.31%, and a transmittance of the imaging lens assembly corresponding to light with the maximum transmittance wavelength from 400 nm to 800 nm is 86.42%.

FIG. 1Y shows the transmittances of the lens elements LE according to the 1st embodiment of FIG. 1A. In FIG. 1Y, the imaging lens assembly can include an optical absorbing lens element, wherein at least one of the lens elements LE can be the optical absorbing lens element. By the cooperation between the optical absorbing lens element and the optical multilayer deposition structure layer 131, it is favorable for correcting chromatic aberration generated by the optical multilayer deposition structure layer 131 so as to further enhance the effect of light filtering. In detail, the optical multilayer deposition structure layer 131 can be further disposed on the optical absorbing lens element. Further, a wavelength of an absorption peak value AP of the lens elements LE is 698 nm.

It should be mentioned that the range in the dotted line in each of FIG. 1J, FIG. 1M and FIG. 1P is the range of the light path L.

### <2nd Embodiment>

FIG. 2A is a three-dimensional schematic view of a camera module 20 according to the 2nd embodiment of the present disclosure. FIG. 2B is a partial cross-sectional view of the camera module 20 according to the 2nd embodiment of FIG. 2A. FIG. 2C is a cross-sectional view of the camera module 20 according to the 1st example of the 2nd embodiment of FIG. 2A. As shown in FIG. 2A to FIG. 20, the camera module 20 includes an image sensor module (its reference numeral is omitted), an imaging lens assembly 22 and a carrier 265, wherein the imaging lens assembly 22 is disposed on an object side of the image sensor module along a light path L, and the carrier 265 is used to carry the imaging lens assembly 22 and the image sensor module.

FIG. 2D is a partial enlarged view of the camera module 20 according to the 1st example of the 2nd embodiment of FIG. 2C. FIG. 2E is another partial enlarged view of the camera module 20 according to the 1st example of the 2nd embodiment of FIG. 2C. As shown in FIG. 2B to FIG. 2E, the image sensor module has the light path L, and includes an image sensor 210, a reflecting element 220a, an optical multilayer deposition structure layer 231 and a nano-rough surface 240. The image sensor 210 corresponds to the light path L. The reflecting element 220a faces towards and is adjacent to the image sensor 210, and the reflecting element 220a is configured to fold the light path L. The optical multilayer deposition structure layer 231 is farther away from the image sensor 210 than the reflecting element 220a away from the image sensor 210 along the light path L, and the optical multilayer deposition structure layer 231 is disposed on an object side of the reflecting element 220a. The nano-rough surface 240 is disposed on one side of the image sensor 210 facing towards the reflecting element 220a, and the nano-rough surface 240 includes a plurality of nano-protruding structures (its reference numeral is omitted). Shapes of the nano-protruding structures are irregular, and the nano-protruding structures are arranged adjacent to each other.

As shown in FIG. 2B and FIG. 2C, the camera module 20 can further include an object-side reflecting element 220b, wherein the object-side reflecting element 220b is disposed on an object side of the image sensor module. Further, the object-side reflecting element 220b is disposed on the object side of the reflecting element 220a.

As shown in FIG. 2A to FIG. 2C, the camera module 20 can further include a substrate 264, a circuit E, a driver 291 and an image processing element 292, wherein the circuit E is disposed on a surface of the substrate 264, and the driver 291 and the image processing element 292 are disposed on the circuit E.

As shown in FIG. 2E, the image sensor module can further include a holder element 261 and an air gap 262. The holder element 261 is configured to cover on the image sensor 210, and the reflecting element 220a is disposed on the holder element 261. The air gap 262 is formed between the reflecting element 220a and the image sensor 210, the holder element 261 surrounds the air gap 262, and the nano-rough surface 240 and the air gap 262 at least partially overlap on the light path L.

Further, the nano-rough surface 240 extends from an image sensing surface IMG towards the holder element 261, and the nano-rough surface 240 is disposed on at least one part of the holder element 261, wherein the nano-rough surface 240 is further disposed on an inner sidewall 263 of the holder element 261.

As shown in FIG. 2C and FIG. 2E, the reflecting element 220a can include a prism (its reference numeral is omitted), wherein the prism includes a light incident surface 221, at least one reflecting surface 222 and a light exiting surface 223 along the light path L. The light exiting surface 223 faces towards and is adjacent to the nano-rough surface 240, and the light exiting surface 223 faces towards and is adjacent to the image sensing surface IMG. Further, the optical multilayer deposition structure layer 231 is disposed on the light incident surface 221. Therefore, the surface reflection generated by the optical multilayer deposition structure layer 231 and the light incident surface 221 can be avoided. Further, the optical multilayer deposition structure layer 231 can be directly disposed on the light incident surface 221, but the present disclosure is not limited thereto.

As shown in FIG. 2D, the object-side reflecting element 220b can include an infrared light absorbing coating layer 232, a reflective layer 234 and a red light absorbing glass 272, wherein the light path L passes through the infrared light absorbing coating layer 232. The nano-rough surface 240 is disposed on one side of the red light absorbing glass 272, the infrared light absorbing coating layer 232 is disposed on another side of the red light absorbing glass 272, and the reflective layer 234 is disposed on the infrared light absorbing coating layer 232. Further, a thickness of the infrared light absorbing coating layer 232 can be between 900 nm to 5 μm.

FIG. 2F is a partial schematic view of the camera module 20 according to the 2nd example of the 2nd embodiment of FIG. 2A. FIG. 2G is a partial enlarged view of the camera module 20 according to the 2nd example of the 2nd embodiment of FIG. 2F. As shown in FIG. 2F and FIG. 2G, the optical multilayer deposition structure layer 231 is disposed on the light incident surface 221 of the reflecting element 220a, the infrared light absorbing coating layer 232 is disposed on the reflecting surface 222 of the reflecting element 220a, and the reflecting element 220a is fixed on the holder element 261 by a glue G. Further, the nano-rough surface 240 is disposed on the light exiting surface 223 of the reflecting element 220a and the image sensor 210.

It should be mentioned that when the infrared light absorbing coating layer 232 is disposed on the reflecting surface 222, it is equivalent to passing through the infrared light absorbing coating layer 232 twice. Therefore, the thickness of the coating layer can be reduced.

FIG. 2H is a partial schematic view of the camera module 20 according to the 3rd example of the 2nd embodiment of FIG. 2A. As shown in FIG. 2H, the image sensor module can further include a filter 270, wherein the filter 270 is disposed on the light incident surface 221 of the reflecting element 220a, and the filter 270 includes a red light absorbing board 271. The optical multilayer deposition structure layer 231 is disposed on one side of the red light absorbing board 271, and the infrared light absorbing coating layer 232 is disposed on another side of the red light absorbing board 271.

Further, the aforementioned structure can be formed by adhering the filter 270 to the prism, but the present disclosure is not limited thereto.

FIG. 21 is a partial schematic view of the camera module 20 according to the 4th example of the 2nd embodiment of FIG. 2A. FIG. 2J is a partial enlarged view of the camera module 20 according to the 4th example of the 2nd embodiment of FIG. 21. As shown in FIG. 21 and FIG. 2J, the reflecting element 220a can include a reflecting mirror 251, a frame 252, a plate element 254 and the nano-rough surface 240. The reflecting mirror 251 is configured to fold the light path L, and the frame 252 and the reflecting mirror 251 can be integrally formed by the insert molding method so as to reduce the assembly tolerance and simplify the assembling process. The plate element 254 is disposed on the frame 252, and the nano-rough surface 240 is disposed on at least one part of the reflecting mirror 251 and the frame 252.

In detail, by reducing the weight of the reflecting element 220a, the weight of the image sensor module can be reduced, and the energy and time consumed in driving the reflecting element 220a can be indirectly reduced. Further, by the arrangement of the nano-rough surface 240, the reflection generated at a surface of a substrate 255 of the reflecting mirror 251 can be reduced to avoid ghosting, and glare caused by the reflection of the frame 252 can be reduced. Specifically, the reflective layer 234 is disposed on the substrate 255. Further, a reflecting mirror set 250 is composed of the filter 270, the reflecting mirror 251, the frame 252 and the plate element 254.

FIG. 2K is a partial schematic view of the camera module 20 according to the 5th example of the 2nd embodiment of FIG. 2A. FIG. 2L is a partial enlarged view of the camera module 20 according to the 5th example of the 2nd embodiment of FIG. 2K. As shown in FIG. 2K and FIG. 2L, the reflecting element 220a can include a holder portion 253, and the image sensor module can further include an air gap 262. The holder portion 253 and the image sensor 210 are relatively fixed to each other. The air gap 262 is formed between the reflecting element 220a and the image sensor 210. The holder portion 253 surrounds the air gap 262, and the nano-rough surface 240 and the air gap 262 at least partially overlap on the light path L.

By the arrangement that the reflecting element 220a and the holder portion 253 are integrally formed, the assembling process can be simplified, and the assembly tolerance can be reduced. Therefore, the optical quality can be enhanced. Further, the method for integrally forming the reflecting element 220a and the holder portion 253 can be achieved by the injection molding method, the insert molding method, etc., but the present disclosure is not limited thereto.

FIG. 2M is a partial schematic view of the camera module 20 according to the 6th example of the 2nd embodiment of FIG. 2A. As shown in FIG. 2M, the infrared light absorbing coating layer 232 and the optical multilayer deposition structure layer 231 are disposed on the light incident surface 221 of the reflecting element 220a. In detail, the infrared light absorbing coating layer 232 can cooperate with the optical multilayer deposition structure layer 231. Therefore, light in an infrared wavelength range from entering the image sensing surface IMG can be avoided, thus the optical quality can be enhanced

### <3rd Embodiment>

FIG. 3A is a three-dimensional schematic view of a camera module 30 according to the 3rd embodiment of the present disclosure. FIG. 3B is an exploded view of the camera module 30 according to the 3rd embodiment of FIG. 3A. FIG. 3C is a cross-sectional view of the camera module 30 according to the 3rd embodiment of FIG. 3A. As shown in FIG. 3A to FIG. 3C, the camera module 30 includes an image sensor module 31, an imaging lens assembly 32 and an imaging lens carrier 33, wherein the imaging lens assembly 32 is disposed on an object side of the image sensor module 31 along a light path L, and the imaging lens carrier 33 is used to carry the imaging lens assembly 32.

FIG. 3D is a partial enlarged view of the camera module 30 according to the 3rd embodiment of FIG. 3C. FIG. 3E is an exploded view of the image sensor module 31 according to the 3rd embodiment of FIG. 3A. As shown in FIG. 3C to FIG. 3E, the image sensor module 31 has the light path L, and includes an image sensor 310, a reflecting element 320, an optical multilayer deposition structure layer 331 and a nano-rough surface (not shown). The image sensor 310 corresponds to the light path L. The reflecting element 320 faces towards and is adjacent to the image sensor 310, and the reflecting element 320 is configured to fold the light path L. The optical multilayer deposition structure layer 331 is farther away from the image sensor 310 than the reflecting element 320 away from the image sensor 310 along the light path L, and the optical multilayer deposition structure layer 331 is disposed on an object side of the reflecting element 320. The nano-rough surface is disposed on one side of the image sensor 310 facing towards the reflecting element 320, and the nano-rough surface includes a plurality of nano-protruding structures (not shown). Shapes of the nano-protruding structures are irregular, and the nano-protruding structures are arranged adjacent to each other.

As shown in FIG. 3C and FIG. 3E, the camera module 30 can further include a circuit E, a retainer 366 and an image processing element 392, wherein the image processing element 392 is disposed on the circuit E, and the reflecting element 320 is disposed on the retainer 366.

The image sensor module 31 can further include a holder element 361, an infrared light absorbing coating layer 332 and a filter 370. The holder element 361 is configured to cover on the image sensor 310. The reflecting element 320 is disposed on the holder element 361. The filter 370 includes a red light absorbing board 371, and the optical multilayer deposition structure layer 331 and the infrared light absorbing coating layer 332 are disposed on the red light absorbing board 371.

As shown in FIG. 3C, the imaging lens assembly 32 can include an infrared light absorbing lens 384, wherein the optical multilayer deposition structure layer 331 is disposed on an image-side surface of the infrared light absorbing lens 384.

The reflecting element 320 can include a prism (its reference numeral is omitted), wherein the prism includes a light incident surface 321, five reflecting surfaces 322a, 322b, 322c, 322d, 322e and a light exiting surface 323 along the light path L, and the light exiting surface 323 faces towards and is adjacent to an image sensing surface. In detail, the light incident surface 321, the reflecting surfaces 322b, 322d and the light exiting surface 323 are coplanar.

### <4th Embodiment>

FIG. 4A is a three-dimensional schematic view of a camera module 40 according to the 4th embodiment of the present disclosure. FIG. 4B is an exploded view of the camera module 40 according to the 4th embodiment of FIG. 4A. FIG. 4C is a cross-sectional view of the camera module 40 according to the 4th embodiment of FIG. 4A. As shown in FIG. 4A to FIG. 4C, the camera module 40 includes an image sensor module 41 and two imaging lens assemblies 42a, 42b, and the imaging lens assemblies 42a, 42b are disposed on an object side of the image sensor module 41 along a light path L, wherein the imaging lens assembly 42b is disposed between the imaging lens assembly 42a and the image sensor module 41.

FIG. 4D is an exploded view of the image sensor module 41 according to the 4th embodiment of FIG. 4A. As shown in FIG. 4C and FIG. 4D, the image sensor module 41 has the light path L, and includes an image sensor 410, a reflecting element 420a, an optical multilayer deposition structure layer 431 and a nano-rough surface (not shown). The image sensor 410 corresponds to the light path L. The reflecting element 420a faces towards and is adjacent to the image sensor 410, and the reflecting element 420a is configured to fold the light path L. The optical multilayer deposition structure layer 431 is farther away from the image sensor 410 than the reflecting element 420a away from the image sensor 410 along the light path L, and the optical multilayer deposition structure layer 431 is disposed on an object side of the reflecting element 420a. The nano-rough surface is disposed on one side of the image sensor 410 facing towards the reflecting element 420a, and the nano-rough surface includes a plurality of nano-protruding structures (not shown). Shapes of the nano-protruding structures are irregular, and the nano-protruding structures are arranged adjacent to each other.

As shown in FIG. 4C, the camera module 40 can further include an object-side reflecting element 420b, wherein the object-side reflecting element 420b is disposed on an object side of the image sensor module 41, and the optical multilayer deposition structure layer 431 is disposed on the object-side reflecting element 420b. Further, the imaging lens assembly 42a includes the object-side reflecting element 420b, and the object-side reflecting element 420b is disposed on the object side of the reflecting element 420a.

As shown in FIG. 4C and FIG. 4D, the reflecting element 420a can include a prism (its reference numeral is omitted), wherein the prism includes a light incident surface 421, at least one reflecting surface 422 and a light exiting surface 423 along the light path L. The light exiting surface 423 faces towards and is adjacent to the nano-rough surface, and the light exiting surface 423 faces towards and is adjacent to an image sensing surface IMG.

The image sensor module 41 can further include a sub-optical multilayer deposition structure layer 433, wherein the sub-optical multilayer deposition structure layer 433 is disposed on the reflecting element 420a.

As shown in FIG. 4C and FIG. 4D, the camera module 40 can further include a circuit E, an image stabilization driver 493 and a focus driver 494, wherein the image sensor 410 is disposed on the circuit E, the object-side reflecting element 420b is disposed on the image stabilization driver 493, and the imaging lens assembly 42b is disposed on the focus driver 494.

The reflecting element 420a can include a holder portion 453, wherein the holder portion 453 and the image sensor 410 are relatively fixed to each other.

### <5th Embodiment>

FIG. 5A is a schematic view of an electronic device 50 according to the 5th embodiment of the present disclosure. FIG. 5B is another schematic view of the electronic device 50 according to the 5th embodiment of FIG. 5A. As shown in FIG. 5A and FIG. 5B, the electronic device 50 is a smart phone, wherein the electronic device 50 can also be a laptop computer, a tablet computer or a dashcam, but the present disclosure is not limited thereto. The electronic device 50 includes camera modules, wherein the camera modules can be the camera modules according to the aforementioned 1st embodiment to the 4th embodiment, but the present disclosure is not limited thereto.

In the 5th embodiment, the camera modules are respectively a front camera module 521, a wide angle camera module 522, a telephoto camera module 523, an ultra-wide angle camera module 524, a macro camera module 525 and a TOF (Time-Of-Flight) module 526. The TOF module 526 can be another type of the camera module, and the disposition is not limited thereto.

Specifically, in the 5th embodiment, the front camera module 521 and the TOF module 526 are disposed on a front of the electronic device 50, and the wide angle camera module 522, the telephoto camera module 523, the ultra-wide angle camera module 524 and the macro camera module 525 are disposed on a back of the electronic device 50.

An imaging control interface 510 can be a touch screen for displaying the scene and having the touch function, and the shooting angle can be manually adjusted. In detail, the imaging control interface 510 includes an image replay button 511, a camera module switching button 512, a focus capturing button 513, an integrated menu button 514 and a zoom control button 515. Further, users enter a shooting mode via the imaging control interface 510 of the electronic device 50, the camera module switching button 512 can be flexibly configured to switch one of the front camera module 521, the wide angle camera module 522, the telephoto camera module 523, the ultra-wide angle camera module 524 and the macro camera module 525 to capture the image, and the zoom control button 515 is configured to adjust the zoom. The users use the focus capturing button 513 to undergo image capturing after capturing the images and confirming one of the front camera module 521, the wide angle camera module 522, the telephoto camera module 523, the ultra-wide angle camera module 524 and the macro camera module 525. The users can view the images by the image replay button 511 after undergoing image capturing, and the integrated menu button 514 is configured to adjust the details (such as timed photo, photo ratio, etc.) of the image capturing.

The electronic device 50 can further include a reminding light 53, and the reminding light 53 is disposed on the front of the electronic device 50 and can be configured to remind users unread messages, missed calls and the condition of the phone.

Further, after entering the shooting mode via the imaging control interface 510 of the electronic device 50, imaging light is gathered on the image sensor via the camera module, and an electronic signal about an image is output to an image signal processor (its reference numeral is omitted) of a single chip system 55. The single chip system 55 can further include a random access memory (RAM) (its reference numeral is omitted), a central processing unit (its reference numeral is omitted) and a storage unit (its reference numeral is omitted). Also, the single chip system 55 can further include, but not be limited to, a display, a control unit, a read-only memory (ROM), or the combination thereof.

Furthermore, the electronic device 50 can further include an image software processor and the image signal processor, and the image software processor, the image signal processor, a position locator, a transmitting signal processor, a gyroscope, a storage unit and a random access memory can be further integrated in the single chip system 55.

To meet a specification of the electronic device 50, the electronic device 50 can further include an optical anti-shake mechanism (not shown). Further, the electronic device 50 can further include at least one focusing assisting element 56 and at least one sensing element (not shown). The focusing assisting element 56 can include a light emitting element 561 for compensating a color temperature, an infrared distance measurement component (not shown), a laser focus module (not shown), etc. The sensing element can have functions for sensing physical momentum and kinetic energy, such as an accelerator, a gyroscope, a Hall Effect Element, a position locator, a transmitting signal processor, to sense shaking and jitters applied by hands of the user or external environments. Accordingly, the camera module of the electronic device 50 equipped with an auto-focusing mechanism and the optical anti-shake mechanism can be enhanced to achieve the superior image quality. Furthermore, the electronic device 50 according to the present disclosure can have a capturing function with multiple modes, such as taking optimized selfies, high dynamic range (HDR) under a low light condition, 4K resolution recording, etc. Moreover, the users can visually see a captured image of the camera through the imaging control interface 510 and manually operate the view finding range on the imaging control interface 510 to achieve the autofocus function of what you see is what you get.

Further, the camera modules, the optical anti-shake mechanism, the sensing element, the focusing assisting element 56 and an electronic element 542 can be disposed on an electronic board 54 and electrically connected to the associated components, such as the image signal processor, via a connector 541 to perform a capturing process. Specifically, the electronic board 54 can be a flexible printed circuit board (FPC). Since the current electronic devices, such as smart phones, have a tendency of being compact, the way of firstly disposing the camera module and related components on the circuit board and secondly integrating the circuit thereof into the main board of the electronic device via the connector can satisfy the requirements of the mechanical design and the circuit layout of the limited space inside the electronic device, and obtain more margins. The autofocus function of the camera module can also be controlled more flexibly via the touch screen of the electronic device. In the 5th embodiment, the sensing element and the focusing assisting element 56 are disposed on the electronic board 54 and at least one other flexible printed circuit board (not shown) and electrically connected to the associated components, such as the image signal processor, via corresponding connectors to perform the capturing process. In other examples (not shown herein), the sensing element and the focusing assisting element can also be disposed on the main board of the electronic device or carrier boards of other types according to requirements of the mechanical design and the circuit layout.

Furthermore, the image of the certain range with the high resolution can be captured via the wide angle camera module 522, and the wide angle camera module 522 has the function of the high resolution and the low deformation. Comparing with the image captured via the wide angle camera module 522, the image captured via the telephoto camera module 523 can have narrower visual angle and narrower depth of field. Hence, the telephoto camera module 523 can be configured to capture the moving targets, that is, the telephoto camera module 523 can be driven via an actuator (not shown) of the electronic device 50 to quick and continuous auto focus the moving targets, so as to make the image of the moving targets is not fuzzy owing to defocus. Comparing with the image captured via the wide angle camera module 522, the image captured via the ultra-wide angle camera module 524 can have wider visual angle and wider depth of field, but the image captured via the ultra-wide angle camera module 524 also has greater distortion.

Specifically, the zooming function can be obtained via the electronic device 50 when the scene is captured via the camera module with different focal lengths cooperated with the function of image processing.

### <6th Embodiment>

FIG. 6 is a schematic view of an electronic device (its reference numeral is omitted) according to the 6th embodiment of the present disclosure disposed on an unmanned aerial vehicle 60. As shown in FIG. 6, the electronic device includes camera modules, wherein the camera modules can be the camera modules according to the aforementioned 1st embodiment to the 4th embodiment, but the present disclosure is not limited thereto.

In the 6th embodiment, the camera modules are respectively a front camera module 61a, a side camera module 61b and a bottom camera module 61c.

Specifically, the front camera module 61a is disposed on a front end of the unmanned aerial vehicle 60, the side camera module 61b is disposed on a side of the unmanned aerial vehicle 60, and the bottom camera module 61c is disposed on a bottom end of the unmanned aerial vehicle 60. Therefore, complicated ambient light can be conquered via the electronic device.

### <7th Embodiment>

FIG. 7 is a schematic view of an electronic device (its reference numeral is omitted) according to the 7th embodiment of the present disclosure disposed on a vehicle 70. As shown in FIG. 7, the electronic device includes camera modules, wherein the camera modules can be the camera modules according to the aforementioned 1st embodiment to the 4th embodiment, but the present disclosure is not limited thereto.

In the 7th embodiment, the camera modules are respectively a front camera module 71a, a side camera module 71b and a rear camera module 71c.

By the arrangement that the front camera module 71a, the side camera module 71b and the rear camera module 71c are respectively disposed on the front end, the side and the rear end of the vehicle 70, it is favorable for drivers to obtain the external space information in addition to the vehicle 70, such as the external space information 11, 12, 13, 14, but the present disclosure is not limited thereto. Therefore, more visual angles can be provided to reduce the blind spot, so that the driving safety can be enhanced.

### <8th Embodiment>

FIG. 8 is a schematic view of an electronic device (its reference numeral is omitted) according to the 8th embodiment of the present disclosure disposed on a computer 80. As shown in FIG. 8, the electronic device includes camera modules. Further, the camera modules can be the camera modules according to the aforementioned 1st embodiment to the 4th embodiment, but the present disclosure is not limited thereto.

In the 8th embodiment, the camera module are respectively an infrared camera module 81a and a video camera module 81b, wherein both of the infrared camera module 81a and the video camera module 81b are disposed on a front of the computer 80.

### <9th Embodiment>

FIG. 9 is a schematic view of an electronic device (its reference numeral is omitted) according to the 9th embodiment of the present disclosure disposed on a wearable device 90. As shown in FIG. 9, the electronic device includes a camera module. Further, the camera module can be the camera module according to the aforementioned 1st embodiment to the 4th embodiment, but the present disclosure is not limited thereto.

In the 9th embodiment, the camera module is a video camera module 91, wherein the video camera module 91 is disposed on a front of the wearable device 90.

The foregoing description, for purpose of explanation, has been described with reference to specific examples. It is to be noted that Tables show different data of the different examples; however, the data of the different examples are obtained from experiments. The examples were chosen and described in order to best explain the principles of the disclosure and its practical applications, to thereby enable others skilled in the art to best utilize the disclosure and various examples with various modifications as are suited to the particular use contemplated. The examples depicted above and the appended drawings are exemplary and are not intended to be exhaustive or to limit the scope of the present disclosure to the precise forms disclosed. Many modifications and variations are possible in view of the above teachings.

What is claimed is:

1. An image sensor module, which has a light path, comprising:
an image sensor corresponding to the light path;
a reflecting element facing towards and being adjacent to the image sensor, and the reflecting element configured to fold the light path;
an optical multilayer deposition structure layer being farther away from the image sensor than the reflecting element away from the image sensor along the light path, wherein a reflectance of the optical multilayer deposition structure layer corresponding to a light with a wavelength from 450 nm to 600 nm is less than or equal to 10%; and
a nano-rough surface disposed on one side of the image sensor facing towards the reflecting element, wherein the nano-rough surface comprises a plurality of nano-protruding structures, shapes of the nano-protruding structures are irregular, the nano-protruding structures are arranged adjacent to each other, a width of each of the nano-protruding structures is smaller than or equal to 300 nm, and a height of each of the nano-protruding structures is smaller than or equal to 350 nm;
wherein a reflectance of the nano-rough surface corresponds to a reflectance of the optical multilayer deposition structure layer, a wavelength with a reflectance of the optical multilayer deposition structure layer being 50% is R50, a maximum reflectance of the nano-rough surface corresponding to a wavelength from 450 nm to R50 is less than or equal to 0.49%, and the following condition is satisfied:
600 nm≤R50≤720 nm.

2. The image sensor module of claim 1, wherein the reflecting element comprises:
a prism comprising a light incident surface, at least one reflecting surface and a light exiting surface along the light path;
wherein the light exiting surface faces towards and is adjacent to the nano-rough surface.

3. The image sensor module of claim 2, wherein the optical multilayer deposition structure layer is disposed on the light incident surface.

4. The image sensor module of claim 2, wherein the prism is a red light absorbing element.

5. The image sensor module of claim 2, wherein at least one of the light incident surface, the at least one reflecting surface and the light exiting surface of the prism comprises an aspheric surface, and the aspheric surface is disposed corresponding to the light path.

6. The image sensor module of claim 2, wherein the prism further comprises:
a plurality of concave structures arranged adjacent to each other and gradually tapered along a direction close to the light path, and each two of the concave structures adjacent to each other forming a tip;
wherein a distance of each two of the tips adjacent to each other is between 0.3 mm to 2.9 mm.

7. The image sensor module of claim 2, wherein the prism is a glass element;
wherein the prism further comprises a gate trace, and the prism is injection molded by the gate trace.

8. The image sensor module of claim 7, wherein the prism further comprises:
an edge surface, wherein the gate trace extends from the edge surface towards a direction away from the light path;
wherein the gate trace is gradually broadened along a direction close to the edge surface.

9. The image sensor module of claim 1, wherein the reflecting element comprises:
a reflecting mirror configured to fold the light path.

10. The image sensor module of claim 9, wherein the reflecting element further comprises:
a frame, wherein the frame and the reflecting mirror are integrally formed by an insert molding method.

11. The image sensor module of claim 10, wherein the reflecting element further comprises:
a nano-rough surface disposed on at least one part of the reflecting mirror and the frame.

12. The image sensor module of claim 1, further comprising:
a holder element configured to cover on the image sensor, wherein the reflecting element is disposed on the holder element; and
an air gap formed between the reflecting element and the image sensor, wherein the holder element surrounds the air gap, and the nano-rough surface and the air gap at least partially overlap on the light path.

13. The image sensor module of claim 12, wherein the nano-rough surface extends from an image sensing surface towards the holder element, and the nano-rough surface is disposed on at least one part of the holder element.

14. The image sensor module of claim 1, wherein the reflecting element comprises a holder portion, and the holder portion and the image sensor are relatively fixed to each other;
wherein the image sensor module further comprises an air gap formed between the reflecting element and the image sensor, the holder portion surrounds the air gap, and the nano-rough surface and the air gap at least partially overlap on the light path.

15. The image sensor module of claim 1, further comprising:
an infrared light absorbing coating layer disposed on the reflecting element;
wherein a thickness of the infrared light absorbing coating layer is between 900 nm to 5 μm.

16. The image sensor module of claim 1, further comprising:
a filter comprising a red light absorbing board, wherein the optical multilayer deposition structure layer is disposed on the red light absorbing board.

17. The image sensor module of claim 1, wherein the image sensor comprises:
a plurality of pixel units, wherein a pixel size of each of the pixel units is between 400 nm to 2000 nm, and any one of the pixel units comprises a microlens;
wherein the nano-rough surface is disposed on the microlens of the any one of the pixel units.

18. A camera module, comprising:
the image sensor module of claim 1; and
an imaging lens assembly disposed on an object side of the image sensor module along the light path.

19. The camera module of claim 18, further comprising:
an object-side reflecting element disposed on the object side of the image sensor module, and the optical multilayer deposition structure layer disposed on the object-side reflecting element.

20. The camera module of claim 19, wherein the imaging lens assembly comprises:
an object-side lens set disposed on an object side of the object-side reflecting element.

21. The camera module of claim 19, wherein the imaging lens assembly comprises:
an image-side lens set disposed between the object-side reflecting element and the image sensor module, wherein the optical multilayer deposition structure layer is disposed between the image-side lens set and the reflecting element.

22. The camera module of claim 18, further comprising:
an object-side reflecting element disposed on an object side of the reflecting element;
wherein the object-side reflecting element comprises an infrared light absorbing coating layer, the light path passes through the infrared light absorbing coating layer, and a thickness of the infrared light absorbing coating layer is between 900 nm to 5 μm.

23. The camera module of claim 18, wherein the imaging lens assembly comprises:
a plurality of lens elements sequentially arranged along the light path, and the optical multilayer deposition structure layer disposed on one of the lens elements.

24. The camera module of claim 23, wherein the imaging lens assembly further comprises:
a lens set, wherein the lens set and the reflecting element are relatively fixed to each other;
wherein the optical multilayer deposition structure layer is disposed on the lens set.

25. The camera module of claim 23, wherein the imaging lens assembly further comprises:
an optical absorbing lens element, wherein an absorption peak value of the optical absorbing lens element is between 600 nm to 800 nm.

26. The camera module of claim 23, wherein the image sensor module further comprises:
a sub-optical multilayer deposition structure layer disposed on the reflecting element, wherein a reflectance of the sub-optical multilayer deposition structure layer corresponding to a light with a wavelength from 450 nm to 550 nm is less than or equal to 10%, a wavelength with a reflectance of the sub-optical multilayer deposition structure layer being 50% is R50′, and the following condition is satisfied:
600 nm≤R50′≤720 nm.

27. The camera module of claim 23, wherein an average transmittance of the imaging lens assembly corresponding to a light with a wavelength from 700 nm to 800 nm is less than or equal to 5%, and a transmittance of the imaging lens assembly corresponding to a light with a maximum transmittance wavelength from 400 nm to 800 nm is greater than or equal to 82%.

28. The camera module of claim 18, wherein the width of each of the nano-protruding structures is smaller than or equal to 250 nm, and the height of each of the nano-protruding structures is smaller than or equal to 250 nm;
wherein a layer number of the optical multilayer deposition structure layer is greater than 30;
wherein the imaging lens assembly comprises an optical absorbing lens element, and an absorbing peak value of the optical absorbing lens element is between 650 nm to 750 nm;
wherein an average transmittance of the imaging lens assembly corresponding to a light with a wavelength from 700 nm to 800 nm is less than or equal to 1%, and a transmittance of the imaging lens assembly corresponding to a light with a maximum transmittance wavelength from 400 nm to 800 nm is greater than or equal to 85%;
wherein the wavelength with the reflectance of the optical multilayer deposition structure layer being 50% is R50, the maximum reflectance of the nano-rough surface corresponding to the wavelength from 450 nm to R50 is less than or equal to 0.2%, and the following condition is satisfied:
650 nm≤R50≤700 nm.

29. An electronic device, comprising:
the camera module of claim 18.
